(19) United States
(12) Patent Application Publication
(10) Pub. No.: US 2016/0159125 A1
(43) Pub. Date: Jun. 9, 2016

(54) SUBLIMATION PROCESS CONTROL

(71) Applicant: AirDye Intellectual Property LLC, Harrisonburg, VA (US)

(72) Inventor: Jesse Leskanic, Gaffney, SC (US)

(73) Assignee: AirDye Intellectual Property LLC, Harrisonburg, VA (US)

(21) Appl. No.: 14/877,886

(22) Filed: Oct. 7, 2015

Related U.S. Application Data
(60) Provisional application No. 62/061,394, filed on Oct. 8, 2014.

(51) Int. Cl. B41M 5/382

(52) U.S. Cl. CPC B41M 5/38221

(57) ABSTRACT

Methods, systems and computer readable media for sublimation process control are described.

### RELATED APPLICATIONS

This application claims the benefit of U.S. Provisional Patent Application No. 62/061,394, entitled “Fabric Characterization and Calendaring”, filed on Oct. 8, 2014, which is incorporated herein by reference in its entirety.

### TECHNICAL FIELD

Embodiments relate generally to dyeing equipment, and more particularly, to methods, systems and computer readable media for sublimation process control.

### BACKGROUND

Throughout the existence of mankind, humans have always found a way to decorate fabric with colors. Starting with hides and later woven and knitted materials, the traditional approach has been to liquefy the color by suspending it in a solution of water or some other fluid. The object to be dyed is then submersed in the solution or coated with it to produce the desired color. This traditional process is, in some ways, similar to conventional vat dyeing processes used in industry today.

Skill may be required to produce a desired color using the conventional vat dyeing methods. Skill may also be required to produce “dye lots” of the same color, sometimes referred to in the textile industry as matching yields, even with today's relatively sophisticated equipment. Producing an exact color match is a product of re-creating the exact intersection of color concentration, energy (usually heat), object material, and processing time repeatedly in a chamber with potentially changing dynamics.

At the present time, skilled craftsmen all over the world dye more than 25 million tons of polymer based fabric annually using derivatives of these ancient techniques. The conventional vat dyeing processes result in tons of clothing, home fashion products, and other products being produced annually, and, unfortunately, also significantly contribute to the amount of water pollution. As new sources of fiber (mostly polymer based) are developed, the application of these ancient skills has become more difficult and problematic. The net effect can include a decrease of matching yields and an increase of energy use and production of ever greater volumes of dangerous effluents and other process waste or by-products.

One solution to the above-mentioned problems or limitations is to use an extension of dispersed dye sublimation technology (hereafter referred to as DDS or DDS printing). DDS printing has been used for decades to print images on various fabrics and other receiver materials. In a typical DDS process, a specific type of ink (or dye) is printed (or applied) to a first surface of a donor transfer media (e.g., donor transfer paper or other suitable material), and the donor transfer media is juxtaposed against a receiver (e.g., fabric, paper or other substrate suitable for receiving dyes via a dye sublimation process)). When heat is applied to a second surface (e.g., an outside surface opposite the side bearing the ink or dye) of the donor transfer media, the inks or dyes on the donor transfer media explode (or vaporize) into dye laden superheated air and drive the colorant into the receiver material. This use of super-heated air—not water—as the carrying agent can help dramatically reduce pollution and energy use. The use of DDS technology for dyeing fabric and other materials has been practiced for years with limited success that may be due to a number of problems or limitations associated with DDS processes.

A primary problem with DDS is that the process may not deliver sufficient color saturation to replicate the color saturation possible with liquid-based vat dyeing. A common approach historically taken to address this limitation has been to place donor transfer media on both sides of the receiver. However, in some cases this process has not provided sufficient saturation and color replication to replace solution dyeing. For example, two-sided DDS printing may not be able to adequately color knit fabric when stretched and threads that roll during sewing and cutting. Thus, two-sided printing in current equipment may produce results that are commercially unsatisfactory.

Another problem in conventional DDS processes can be the temperature of the receiver as it enters into the process. Generally, conventional starting temperatures of backside donors are between 140° to 170° F., which may not be sufficient to provide desirable saturation of dye coverage. Furthermore, not all dyes are sublimable with DDS. High energy dyes, while delivering stable brilliant colors, may require much higher temperature to phase change which can destroy the receiver during sublimation or alter the receiver in a way that is unacceptable commercially. Because of these and other problems and limitations, DDS has not been used commercially to replace vat dyeing when coverage of large surface areas (e.g. printing of solids) is desired.

Another problem or limitation of conventional DDS printing is that double-sided printing yields colorations that may be different from side to side even when the same ink or dye is used on the donor transfer media on both sides. One reason for this limitation may be that the second application of heat tends to vaporize the first application of dye out of the donor transfer media and onto a take-up paper.

Still another problem or limitation of DDS printing may be that it is an entirely additive process. For example, if one desired to print a full color image on a yellow background, one must print on top of the yellow background, which may distort the colors of the image. Where multiple images or multiple passes are used, there can also be significant registering problems.

Thus, there may be a need for sublimation process control techniques to print solids and other integrated designs in a one or two-sided sublimation process that produces printed receiver having substantially matching color results from lot to lot of printed receiver, with better color consistency and/or with improved color saturation.

Embodiments were conceived in light of the above mentioned needs, problems and/or limitations, among other things.

### SUMMARY

One or more embodiments can include methods, systems and computer readable media for controlling dye sublimation (or dye-diffusion) processing equipment. Some implementations can include a method for controlling a calendar machine, the method comprising. The method can include providing a receiver and donor transfer media including a first donor transfer medium and a second donor transfer medium. The method can also include simultaneously applying, with the calendar machine, a first image from the first donor transfer medium on a first surface of the receiver and a second image from the second donor transfer medium on a second surface of the receiver, the calendar machine being configured with a parameter set including a time value, one or more temperature values and a pressure value. The method can further include obtaining, using a spectrophotometer, a first spectral measurement of the first surface of the receiver and a second spectral measurement of the second surface of the receiver, and comparing the first and second spectral measurements with respective reference measurements obtained from a characterization. The method can also include adjusting one or more of the time value, the one or more temperature values and the pressure value when a result of the comparing exceeds a threshold value.

The method can further include initially configuring the calendar machine with an initial parameter set, wherein the initial parameter set for the calendar machine is received from a color management system, and wherein values of the initial parameter set are determined at the color management system based on the reference measurements. The applying can include dye sublimation transfer, and the first donor transfer medium and the second donor transfer medium can each include one or more dyes compatible with dye sublimation transfer. In some implementations, the obtaining, comparing and adjusting are performed by a controller coupled to the calendar machine.

Some implementations can include a method for characterizing a calendar machine. The method can include providing a receiver and characterization donor transfer media including a first characterization donor transfer medium and a second characterization donor transfer medium. The method can also include simultaneously applying, with a calendar machine, a first image from the first characterization donor transfer medium on a first surface of the receiver and a second image from the second characterization donor transfer medium on a second surface of the receiver, the calendar machine being configured with a parameter set including a time value, one or more temperature values and a pressure value. The method can further include obtaining, using a spectrophotometer, a first spectral measurement of the first surface of the receiver and a second spectral measurement of the second surface of the receiver. The method can also include storing data based on the first spectral measurement and the second spectral measurement as a fabric characterization corresponding to the calendar machine.

The method can further include varying one or more of the time value, the one or more temperature values and the pressure value and repeating the simultaneously applying. The applying can include dye sublimation transfer, and the first characterization donor transfer medium and the second characterization donor transfer medium can each include one or more dyes compatible with dye sublimation transfer. The varying, obtaining and storing can be performed by a controller coupled to the calendar machine.

Some implementations can include a calendar system having a calendar machine configured to print both sides of a receiver simultaneously and configured with a parameter set including a time value, one or more temperature values and a pressure value. The system can also include a spectrophotometer configured to obtain spectral measurements from images of both surfaces of a printed receiver, and a controller coupled to the calendar machine and the spectrophotometer, the controller configured to adjust one or more of the time value, the one or more temperature values and the pressure value of the calendar machine based on spectral measurements from the spectrophotometer obtained from the printed receiver, wherein the adjusting is based on comparing the spectral measurements with reference measurements from a characterization.

The calendar machine can be initially configured with an initial parameter set, where the initial parameter set for the calendar machine is received from a color management system, and where values of the initial parameter set are determined at the color management system based on the reference measurements. The calendar machine can be configured to print both sides of the receiver simultaneously using dye sublimation transfer.

Some implementations can include a calendar machine control system having a spectrophotometer configured to obtain spectral measurements from images of both surfaces of a receiver. The system can also include a controller coupled to a calendar machine interface and the spectrophotometer, the controller being configured to provide parameters to a calendar machine, the parameters including one or more of a time value, one or more temperature values and a pressure value, the parameters being determined based on spectral measurements from the spectrophotometer obtained from a receiver printed using the calendar machine. The adjusting can be based on comparing the spectral measurements with reference measurements from a fabric characterization.

The controller can be configured to receive an initial parameter set from a color management system, where values of the initial parameter set are determined at the color management system based on the reference measurements. The calendar machine can be configured to print both side of the receiver simultaneously using dye sublimation transfer. The calendar machine can include a plurality of pulse heaters.

Some implementations can include a calendar system having a calendar machine configured to print at least one side of a receiver based on a parameter set including a time value, one or more temperature values and a pressure value, the calendar machine having an integrated controller. The system can also include a spectrophotometer coupled to the integrated controller and configured to obtain spectral measurements from at least one side of a printed receiver. The integrated controller can be configured to adjust one or more of the time value, the one or more temperature values and the pressure value of the calendar machine based on spectral measurements from the spectrophotometer obtained from the printed receiver, where the adjusting is based on comparing the spectral measurements with reference measurements from a characterization.

The calendar machine can be initially configured with an initial parameter set, where the initial parameter set for the calendar machine is received at the integrated controller from a color management system, and where values of the initial parameter set are determined at the color management system based on the reference measurements. In some implementations, the color management system can be integrated with the calendar machine and controller. The calendar machine can be configured to print the at least one side of the receiver using dye sublimation transfer.

Some implementations can include a calendar system having one or more calendar machines each configured to print at least one side of a receiver and each configured with a corresponding parameter set including a time value, one or more temperature values and a pressure value. The system can also include one or more spectrophotometers each configured to obtain spectral measurements from images of both surfaces of a printed receiver output from a corresponding one of the one or more calendar machines. The system can further include one or more controllers, each controller coupled to a corresponding one of the one or more calendar machines and to a corresponding one of the one or more spectrophotometers, each controller configured to adjust one or more of the time value, the one or more temperature values and the pressure value of the calendar machine based on spectral measurements from the corresponding spectrophotometer obtained from the printed receiver, where the adjusting is based on comparing the spectral measurements with reference measurements from a characterization of a corresponding calendar machine. The system can also include an enterprise resource planning system configured to communicate with each of the one or more controllers.

Each of the one or more calendar machines can be initially configured with an initial parameter set, where the initial parameter set for each calendar machine is received from a color management system within the enterprise resource management system, and where values of the initial parameter set are determined at the color management system based on the reference measurements.

In some implementations, the one or more calendar machines can include a plurality of calendar machines. Each of the one or more calendar machines can be configured to print both sides of the receiver simultaneously using dye sublimation transfer.

Some implementations can include a method for controlling a distributed network of calendar machines. The method can include providing, at each calendar machine in the distributed network of calendar machines, a receiver and donor transfer media including a first donor transfer medium and a second donor transfer medium. The method can also include receiving, at a controller corresponding to each calendar machine, a parameter set including a time value, one or more temperature values and a pressure value, the parameter set being provided by an enterprise resource planning system. The method can further include simultaneously applying, with the calendar machine, a first image from the first donor transfer medium on a first surface of the receiver and a second image from the second donor transfer medium on a second surface of the receiver according to the parameter set.

The method can also include obtaining, at each controller using a spectrophotometer, a first spectral measurement of the first surface of the receiver and a second spectral measurement of the second surface of the receiver. The method can further include transmitting the first spectral measurement and the second spectral measurement from each controller to the enterprise resource planning system. The method can also include comparing, at the enterprise resource planning system, the first and second spectral measurements with respective reference measurements obtained from a characterization, and when a result of the comparing exceeds a threshold value, adjusting one or more of the time value, the one or more temperature values and the pressure value to form an adjusted parameter set.

The method can further include transmitting the adjusted parameter set from the enterprise resource planning system to the controller corresponding to the adjusted parameter set, and when an adjusted parameter set is received at the controller corresponding to the adjusted parameter set, adjusting the calendar machine corresponding to that controller according to the adjusted parameter set.

The method can also include initially configuring the calendar machine with an initial parameter set, where the initial parameter set for the calendar machine is received from a color management system, and where values of the initial parameter set are determined at the color management system based on the reference measurements. The applying can include dye sublimation transfer, and wherein the first donor transfer medium and the second donor transfer medium each include one or more dyes compatible with dye sublimation transfer.

Some implementations can include a nontransitory computer readable medium having software instructions encoded thereon that, when executed by one or more processors, cause the processors to perform operations. The operations can include providing, at each calendar machine in a distributed network of calendar machines, a receiver and donor transfer media including a first donor transfer medium and a second donor transfer medium. The operations can also include receiving, at a controller corresponding to each calendar machine, a parameter set including a time value, one or more temperature values and a pressure value, the parameter set being provided by an enterprise resource planning system, and applying, with each calendar machine, a first image from the first donor transfer medium on a first surface of the receiver and a second image from the second donor transfer medium on a second surface of the receiver according to the parameter set, the first image and the second image being applied simultaneously.

The operations can further include obtaining, at each controller using a spectrophotometer, a first spectral measurement of the first surface of the receiver and a second spectral measurement of the second surface of the receiver, and transmitting the first spectral measurement and the second spectral measurement from each controller to the enterprise resource planning system. The operations can also include comparing, at the enterprise resource planning system, the first and second spectral measurements with respective reference measurements obtained from a characterization, and when a result of the comparing exceeds a threshold value, adjusting one or more of the time value, the one or more temperature values and the pressure value to form an adjusted parameter set.

The operations can also include transmitting the adjusted parameter set from the enterprise resource planning system to the controller corresponding to the adjusted parameter set, and when an adjusted parameter set is received at the controller corresponding to the adjusted parameter set, adjusting the calendar machine corresponding to that controller according to the adjusted parameter set. The operations can further include initially configuring each calendar machine with an initial parameter set, wherein the initial parameter set for the calendar machine is received from a color management system, and wherein values of the initial parameter set are determined at the color management system based on the reference measurements for the respective calendar machine. The applying can include dye sublimation transfer, where the first donor transfer medium and the second donor transfer medium each include one or more dyes compatible with dye sublimation transfer.

Some implementations can include a nontransitory computer readable medium having software instructions encoded thereon that, when executed by one or more processors, cause the processors to perform operations. The operations can include providing a receiver and donor transfer media including a first donor transfer medium and a second donor transfer medium, and simultaneously applying, with the calendar machine, a first image from the first donor transfer medium on a first surface of the receiver and a second image from the second donor transfer medium on a second surface of the receiver, the calendar machine being configured with a parameter set including a time value, one or more temperature values and a pressure value.

The operations can also include obtaining, using a spectrophotometer, a first spectral measurement of the first surface of the receiver and a second spectral measurement of the second surface of the receiver, and comparing the first and second spectral measurements with respective reference measurements obtained from a characterization. The operations can further include adjusting one or more of the time value, the one or more temperature values and the pressure value when a result of the comparing exceeds a threshold value.

The operations can further comprise initially configuring the calendar machine with an initial parameter set, where the initial parameter set for the calendar machine is received from a color management system, and where values of the initial parameter set are determined at the color management system based on the reference measurements.

The applying can include dye sublimation transfer, where the first donor transfer medium and the second donor transfer medium each include one or more dyes compatible with dye sublimation transfer. The obtaining, comparing and adjusting can be performed by a controller coupled to the calendar machine.

Some implementations can include a nontransitory computer readable medium having software instructions encoded thereon that, when executed by one or more processors, cause the processors to perform operations. The operations can include providing a receiver and characterization donor transfer media including a first characterization donor transfer medium and a second characterization donor transfer medium. The operations can also include simultaneously applying, with a calendar machine, a first image from the first characterization donor transfer medium on a first surface of the receiver and a second image from the second characterization donor transfer medium on a second surface of the receiver, the calendar machine being configured with a parameter set including a time value, one or more temperature values and a pressure value. The operations can further include obtaining, using a spectrophotometer, a first spectral measurement of the first surface of the receiver and a second spectral measurement of the second surface of the receiver, and storing data based on the first spectral measurement and the second spectral measurement as a fabric characterization corresponding to the calendar machine.

The operations can further comprise varying one or more of the time value, the one or more temperature values and the pressure value and repeating the simultaneously applying. The applying can include dye sublimation transfer, where the first characterization donor transfer medium and the second characterization donor transfer medium each include one or more dyes compatible with dye sublimation transfer. The varying, obtaining and storing can be performed by a controller coupled to the calendar machine.

In any of the above described implementations, the receiver can include a fabric (e.g., a synthetic fabric material), the donor transfer media can include paper, each calendar machine can include one or more pulse heaters, and each controller can include a programmable logic controller.

### BRIEF DESCRIPTION OF THE DRAWINGS

FIG. 1 is a schematic diagram of an example dye sublimation printing and dyeing apparatus in accordance with at least one implementation.

FIG. 1A is a close up diagram showing details of element 140 from FIG. 1 in accordance with at least one implementation.

FIG. 2 is a close up of the processing equipment of FIG. 1 in accordance with at least one implementation.

FIG. 3 is a perspective view of an example pulse heater in accordance with at least one implementation.

FIG. 4 is an internal view of the heating elements of the pulse heater of FIG. 3 in accordance with at least one implementation.

FIG. 5 is a schematic view of an example reflector within the pulse heater of FIG. 4 in accordance with at least one implementation.

FIG. 6 is a schematic of an example sublimation printing and dyeing apparatus in accordance with at least one implementation.

FIG. 7 is a schematic diagram of an example dye sublimation printing and dyeing apparatus in accordance with at least one implementation.

FIG. 8 is a diagram showing detail of an example dye sublimation printing and dyeing process in accordance with at least one implementation.

FIG. 9 is a diagram of an example sublimation processing and control environment in accordance with at least one implementation.

FIG. 10 is a diagram of an example sublimation processing and control environment including an enterprise resource planning (ERP) system in accordance with at least one implementation.

FIG. 11 is diagram of an example control system for distributed sublimation processing equipment in accordance with at least one implementation.

FIG. 12 is a diagram showing detail of an example sublimation characterization configuration in accordance with at least one implementation.

FIG. 13 is a flow chart of an example method for sublimation characterization in accordance with at least one implementation.

FIG. 14 is a flow chart of an example method for sublimation processing equipment control in accordance with at least one implementation.

FIG. 15 is a diagram of an example computing device configured for sublimation process control in accordance with at least one implementation.

FIGS. 16 and 17 are diagrams of example characterization template images.

### DETAILED DESCRIPTION

Some implementations include sublimation printing. One advantage of sublimation printing is that sublimation printing is a printing process that does not utilize water and can be extremely material efficient. That is, little waste is generated by the transfer process. Sublimation printing or process equipment also has a relatively small equipment ‘footprint’ and can therefore be done inside a simple warehouse. This enables this printing process to be positioned further downstream in the manufacturing supply chain and therefore realize greater cost savings, supply chain efficiencies, and inventory management.

Some implementations described herein use pulse heater technology so that destruction of the fabric hand during a double-sided imaging of a fabric that occurs using a conventional heat transfer process is no longer a restraint. Examples of pulse heater technology are described in U.S. patent application Ser. No. 12/196,585, entitled “Pulse Heating Methods and Apparatus for Printing and Dyeing,” assigned to AirDye Intellectual Property, LLC, and published as U.S. Publication number 2009/0035461 A1. Pulse heater technology has opened up new design and coloration possibilities, and embodiments described herein address processing complexity issues that can be associated with using pulse heater technology.

In some implementations, pulse heater technology can provide an advantage of a single pass production of a double imaged (front and back) fabric without any significant loss to the original hand of the fabric. By imaging both sides of the fabric simultaneously there is also a much greater economic advantage as opposed to processing the fabric two times in the same machine. This imaging is accomplished by utilizing a secondary heat source that is focused on heating the calendar belt or blanket as opposed to only the drum as is presently done in some conventional calendar machines. This allows for the complete transfer of the dyes into the fabric at much lower temperatures and therefore less damaging to the fabric.

This double imaging of a fabric may open up potentially larger markets and opportunities for the use of heat transferred synthetic fabric. These opportunities may include, but are not limited to, the creation of new design potentials for the apparel market as well as the creation of “dyed” appearing fabric without the use of water. Because of the lower temperatures that are utilized during the calendaring process as described herein, the process may be applicable to a much greater range of available fabrics than previously available because of the potential heat damage associated with conventional calendaring processes.

These new coloration and fabric possibilities though do not come without added process difficulties and complexities. Because of the addition of a secondary heat source and the reduction of the temperature the process is now much more sensitive to minor process fluctuations and fabric inconsistencies. As the product is now double imaged in a single pass process, it is imperative that each side of the fabric be controlled and monitored as each side that is imaged has an influence on the results of the opposite side.

The popularity of single sided heat transfer process may be due in part to its waterless process, economic efficiency, small manufacturing footprint, and its simplicity in production capability. A single sided heat transfer process may require very little in the training of capable operators as the process control for a single sided transfer is minimal and the equipment as presently produced is capable of managing the required control is presently widely produced. With the introduction of double-sided heat transfer processes, such as, for example, the AirDye® double sided heat transfer process, the traditional known assumptions or considerations may no longer be true.

Double sided heat transfer processes can be managed through the introduction of a secondary heat source to the vast array of presently installed calendar machines. Though this method of retrofitting existing equipment can be a workable solution, it is not an ideal solution for globalization of the technology nor for maintaining the consistency of the final fabric output by the processes.

A present practice of simultaneously double-sided transfer, such as, for example, the AirDye® double sided heat transfer process, is essentially a ‘dumb’ machine attempting to manage a very complex process for the required quality of the final imaged fabric. This present practice of the process can require that the operator have a significant amount of exposure and experience to the process in order to attempt to judge the required settings of the machine prior to starting the calendar process and then maintain a close control of the process as the fabric is processed. During this process, the operator can be required to constantly make small but necessary changes to the process to compensate for process variables. To further complicate the requirements of the process, the settings required for proper production can require changes as the base fabric is changed. That is, settings may need to change as the conditions of the fabric change. These changes can be, but not limited to, fabric weight, fabric construction, fabric humidity, yarn size, and other fabric conditions.

The process of simultaneously imaging both sides of a fabric is a complex process being managed by a “dumb” machine. This requires that the operator have extensive knowledge in the heat transfer process for consistent quality output from the machine. These requirements can be prone to excessive product inconsistencies and may limit the globalization of the AirDye® double-sided heat transfer process.

Calendaring is a process whereby sublimable, dispersed dyes are transferred from a donor transfer medium (e.g., a piece of donor transfer paper) having sublimable, dispersed dyes printed on the donor transfer medium into a fabric receiver. As used herein, the term ‘sublimable dyes’ refer to dyes that are able to go into gaseous form into fabric as discussed above. Some implementations provide a cost effective, small footprint solution usable with complex designs involving two pieces of donor transfer media (e.g., each having the same or a different design) that can be transferred onto opposite sides of a fabric receiver. For example, a first design from a first printed donor transfer medium can be transferred to a first (or front) side of a fabric receiver, and a second design from a second printed donor transfer medium can be transferred to a second (or back) side of the fabric receiver.

Some implementations can use color management to facilitate calendaring while reducing waste and simplifying the process. Color management can reduce and/or minimize waste, wherein waste is fabric that is unacceptable. Example techniques for color management are described in U.S. Provisional Patent Application No. 61/974,093, entitled “Systems and Methods for Color Management,” filed Apr. 2, 2014, and in International Application No. PCT/US15/23887, entitled “Color Management”, filed on Apr. 1, 2015, both of which are incorporated herein by reference in their entirety.

Some implementations may combine a conventional, “dumb” calendar machine with the disclosed control system and method to make the calendar machine “smart” (e.g., by including more advanced automated process control adjustments according to the method described herein) so that formerly complex processes can be simplified. With the double-sided transfer done simultaneously, each side influences the other. Embodiments control surface appearance and penetration of dye into fabric to minimize influence on the opposite side of the fabric. In one embodiment, a computing system (e.g., Programmable Logic Controller (PLC), etc.) accesses a fabric characterization database. The database stores properties of various fabrics processed by calendar machines (or other sublimation process equipment), and these properties are used for calendar machine control. The PLC is configurable based on information retrieved from the database.

As would be readily apparent to one of ordinary skill in the art, a PLC is a type of digital computing system that can be used for automation of typically industrial electromechanical processes, such as control of machinery used in factory assembly lines. PLCs can be used in many industries and machines. PLCs can be designed for multiple analog and digital inputs and output arrangements, extended temperature ranges, immunity to electrical noise, and resistance to vibration and impact. Programs to control machine operation can be stored in battery-backed-up or non-volatile memory. A PLC is an example of a hard real-time system since output results must be produced in response to input conditions within a limited time, otherwise unintended operation may result.

Embodiments using pulse heater technology allow for single pass production of a double imaged (e.g., front and back) fabric without any significant loss to the original hand of the fabric. By imaging both sides of the fabric simultaneously there is also a much greater economic advantage as opposed to processing the fabric two times in the same machine. This imaging is accomplished by utilizing a secondary heat source that is focused on heating the calendar belt (also known as a calendar blanket) as opposed to only the drum as is presently done in a calendar machine. This allows for a more complete transfer of the dyes into the fabric at much lower temperatures and therefore less damaging to the fabric.

Simultaneously imaging both sides of a fabric can be a complex process, as mentioned above. This complex process can be difficult to manage with a conventional “dumb” calendar machine (e.g., a calendar machine that has controls that are manually adjusted). This can require that the operator have extensive knowledge in the heat transfer process for consistent quality. In some implementations, a calendar machine is configured to be “smart” by adding a control system as described herein. The control system can automatically perform sublimation process controls so that the process can be simplified to reduce the level of knowledge required by the operator to produce consistent printing products. In some implementations, the process variables that must be controlled for proper and consistent quality of the final product at the machine level include temperature (e.g., of the drum and calendar belt), pressure, and time. Some conventional calendar machines that are presently produced have controls for the manual setting of all of these example variables. The introduction of the AirDye® Pulse Heater adds a second set of temperature variables that must be controlled. This second heat source greatly increases not only the complexity but also increases the level of control that is required. The present state of the equipment in the market does not currently allow for a constant level of control that may be required by a dual heat source system.

Adding to this complexity is that each of these variables and the proper setting of these variables will change depending on the type of fabric that the machine is processing. The settings that can be required for specific fabrics can be presently delivered with AirDye® produced heat transfer media (e.g., paper). These settings are gathered during a fabric characterization process. This fabric characterization is depicted in the figures and described below.

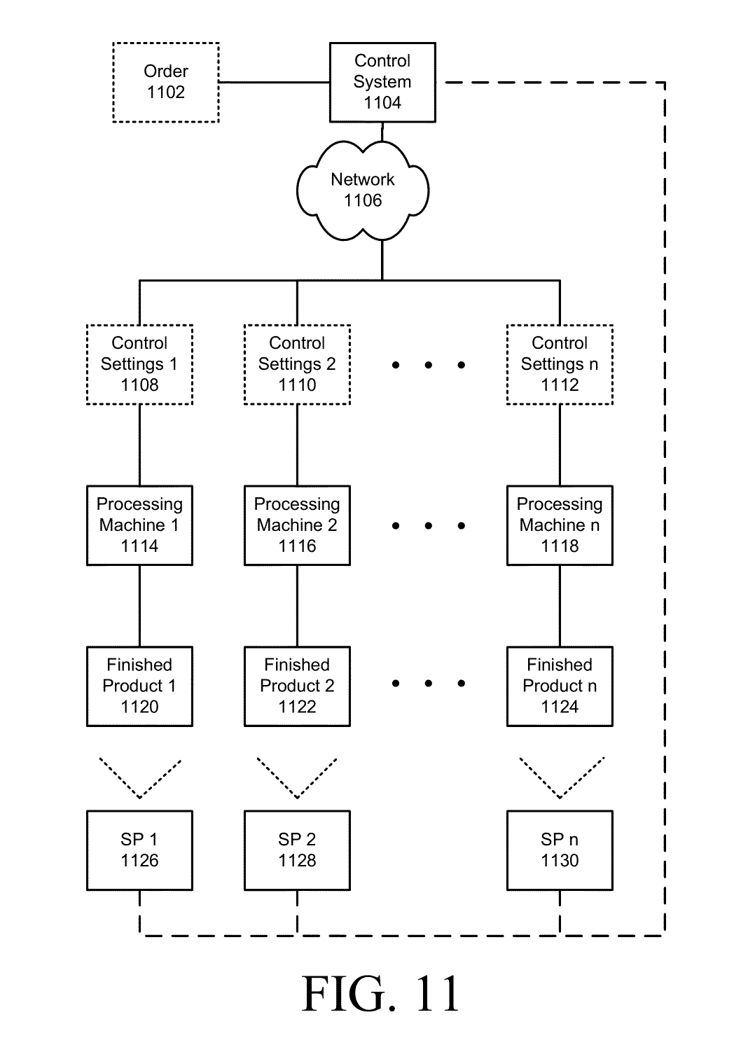

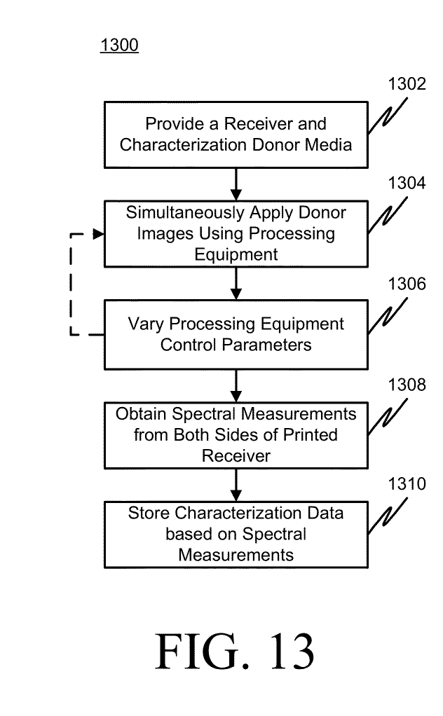

In some implementations, fabric characterization is a process in which a specific fabric receiver is printed in a specific calendar machine, such as, for example, calendar machine 1010 shown in FIG. 10 with AirDye® pulse heater technology, under varying conditions and the results of the image are objectively tested for performance and dye acceptance as these conditions are varied. These data points are then stored in a database (e.g., fabric characterization database 1205 of FIG. 12 or cloud database 1005 of FIG. 10) for further review and instructions from these points are then generated for production of these stored fabric types. These data points are inclusive of but not limited to dye uptake, dye pass through during single and double sided transfer, air permeability, dye permeability, wet crock, dry crock, hand (e.g., the feel of the fabric), seam quality, sewing quality, color fastness to light, color fastness to washing, and others. As would be readily apparent to one of ordinary skill in the art, wet and dry crock is a measurement of how much dye will rub off of a fabric when the fabric is wet and dry, respectively. Dry crock can often be a more important measurement, but wet crock can be more important for certain fabrics and applications, such as, for example, bathing suits, towels, and outdoor furniture fabric. If a heat transfer process does not use the proper amount of heat, dye will rub off of the fabric. Dry and wet crock measurements can indicate how much dye will rub off of fabric is taken when the fabric is dry versus wet. These measurements can indicate whether sufficient heat was used to ensure that the dye is inside fiber as opposed to just being on surface, without using excessive heat, which can negatively affect the ‘hand’ of the fabric (e.g., the feel of the fabric).

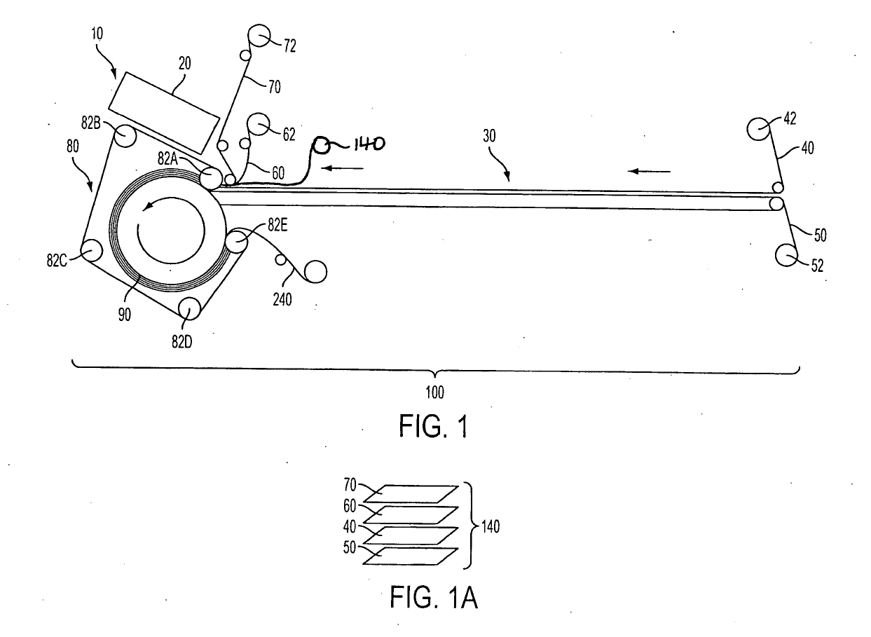

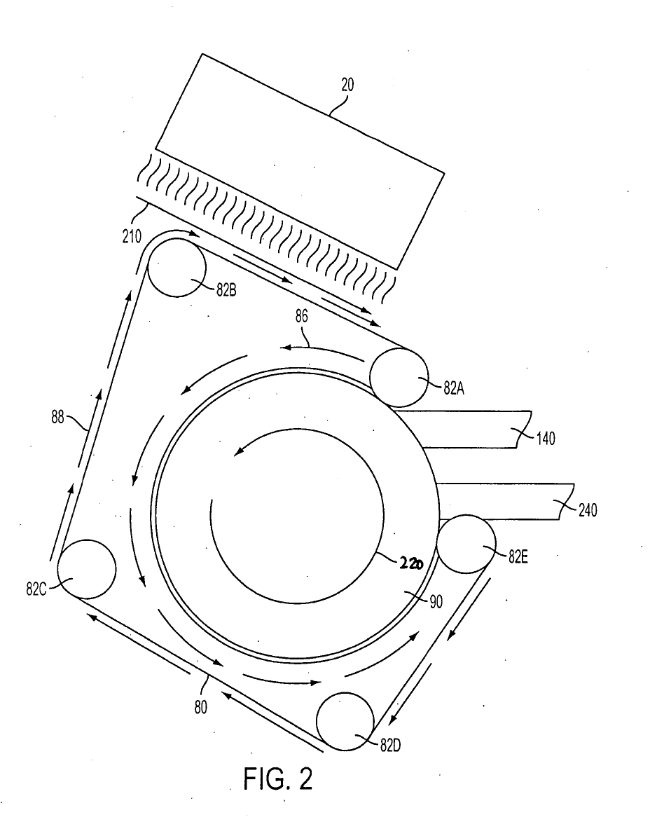

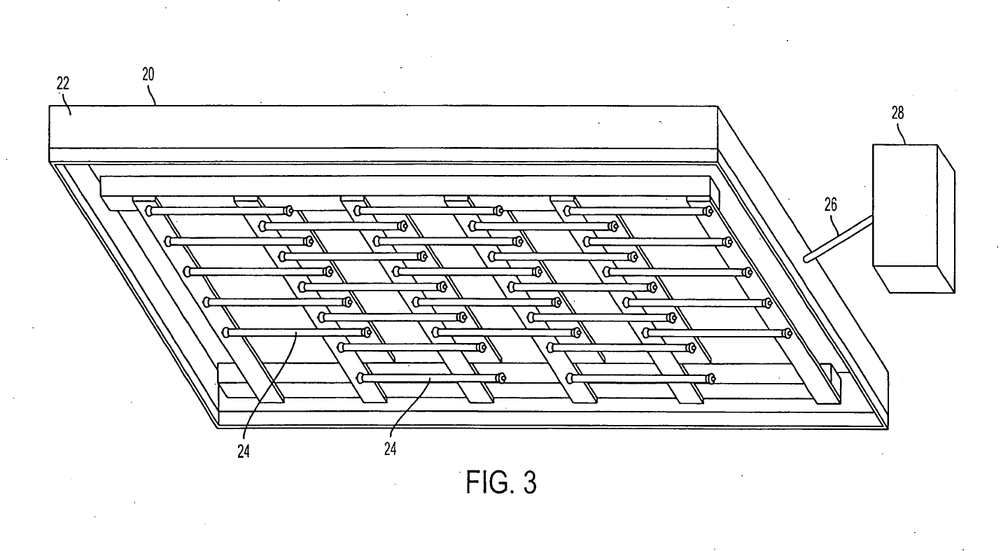

As mentioned above, in some implementations, a sublimation process system can include a pulse heater and a pulse heating station to manufacture a printed fabric (or other substrate). For example, as shown in FIGS. 1 and 2, processing equipment 100 includes a rotary heating portion 10, a pulse heater 20 and a take-up belt 30.

Positioned on the equipment 100 is a continuous take-up belt 30 that serves as a worktable. At one end, the take-up belt 30 is attached to the rotary heating portion 10 and on the opposite end, the take-up belt 30 takes up a receiver 40 from a receiver feed roll 42 and a first donor 50 from a first donor feed roll 52. The first donor 50 is placed against the take-up belt 30 as the receiver 40 is placed on top of the first donor 50. As the processing equipment 100 starts to operate, the take-up belt 30 moves the receiver 40-first donor 50 and upon entry to the rotary heating portion 10, the take-up belt 30 also takes up a second donor 60 from a second donor feed roll 62 and a tissue 70 from a tissue feed roll 72 forming a sandwiched receiver 140 that includes the following layers: a top layer of tissue 70, a second donor 60, a receiver 40, and a first donor 50.

The rotary heating portion 10 comprises a calendar belt 80 and a drum 90 to heat and press dyes from the donors (50 and 60) onto the receiver 40. The calendar belt 80 is situated around drum 90 and travels through positioners 82A-82E. As the processing equipment 100 operates, the calendar belt 80 takes up the sandwiched receiver 140 and moves it against the side of drum 90 in a counter-clockwise direction from positioners 82A to 82E forming inner path 86, to generate a finished receiver 240. As the finished receiver 240 exits the processing equipment 100, the calendar belt 80 moves along in a clockwise direction away from the drum 90 and from positioners 82E to 82D to 82C to 82B, and back to 82A to form outer path 88 and travels back again to the inner path 86 as shown in FIG. 2.

The orientation and placement of positioners 82A and 82E preferably enable calendar belt 80 to press sandwiched receiver 140 against drum 90. The number of positioners may vary depending on the processing equipment. It follows the length of the calendar belt varies according to the type of the machine. The width of the calendar belt preferably is at least 150 cm (60 in) wide but again, according to the different type of commercially viable processing equipment and/or the types of donor or receiver, the width of the belt may vary accordingly. Preferably, the belt is made from a flame-resistant meta-aramid material, more preferably made from the brand Nomex® fiber.

Pulse heater 20 preferably is located above outer path 88 between positioners 82B and 82A, which is also shown in more details in FIG. 2. When pulse heater 20 is in operation it generates intense heat against calendar belt 80 as the belt travels along outer path 88, clockwise from positioners 82B to 82A. In effect, the pulse heater is subjecting calendar belt 80 through a heat application passage 210. When take-up belt 30 moves receiver 40 and first donor 50 into rotary heating portion 10, calendar belt 80 is being heated briefly by pulse heater 20. As the belt 80 moves along rotary heating portion 10, kinetic energy is generated and is increased by the heat generated from the pulse heater. At the moment when sandwiched receiver 140 enters into the rotary heating portion 10, first donor 50 is pressed against drum 90 as second donor 60 is pressed against calendar belt 80. Preferably, as calendar belt 80 moves along, it travels clockwise into the inner path portion 86 and still carries the remaining heat generated from the pulse heater 20. The calendar belt 80 pressed the sandwiched receiver 140 by making direct contact with tissue 70, which is positioned against second donor 60 and pressed down against receiver 40 and first donor 50, which is pressed against drum 90. In essence, the sandwiched receiver 140 is being subjected to a phase change passage 220 in which the kinetic energy generated from the heat application passage 210 is being transferred from calendar belt 80 so that second donor 60 undergoes a phase change to allow the dyes to be transferred brilliantly into receiver 40. This process subjects the sandwiched receiver 140 to a dissipating yet intense heat from the belt as it enters the rotary heating portion. Preferably, drum 90 simultaneously generates a constant heat to cause a phase change in first donor 50, allow dyes to transfer onto receiver 40 and enhance the transfer of dye from the second donor 60. This allows two donors to be simultaneously processed onto a receiver for brilliant and uniformed print and dye application. The length of phase change passage is preferably at least 20% as long as heat transfer passage. In some cases, the application of dissipating heat to the sandwiched receiver 140 can happen no more than five seconds before the application of constant heat generated from drum 90. As sandwiched receiver 140 continues to travel in rotary portion 10, it is still being heated by the calendar belt 80 and the drum 90, this process allows the dyes on the second and first donor (50 and 60) to continue to phase change so they are gradually absorbed or captured by the receiver 40 brilliantly and deeply.

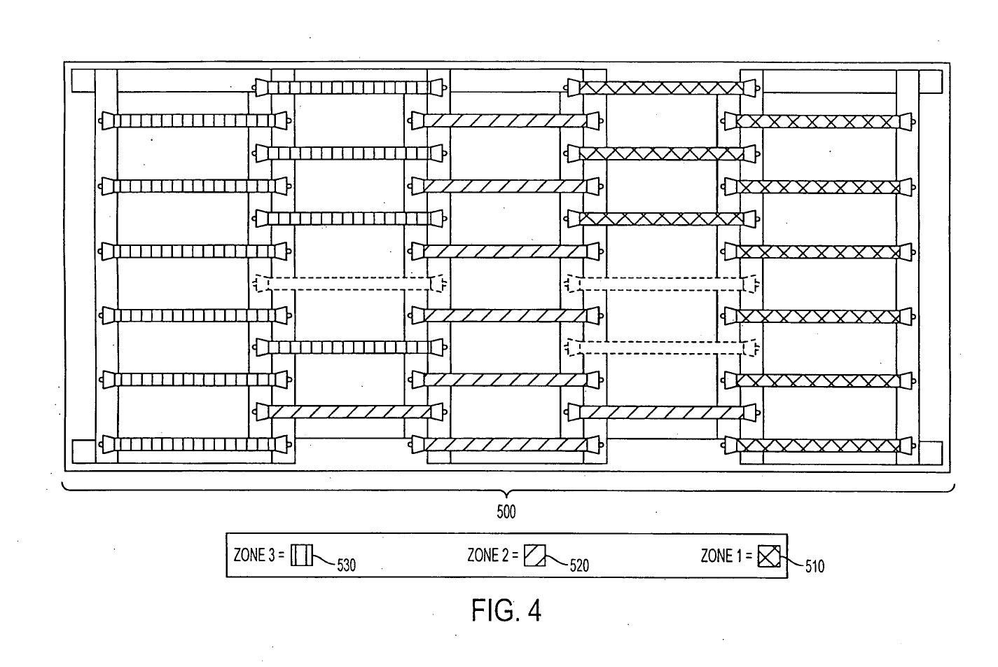

The pulse heater 20 preferably is a heat source that can generate intense heat uniformly applied across the width of calendar belt 80. As shown in FIG. 3, pulse heater 20 preferably comprises a housing 22, a series of heating elements 24 stored within the housing 22; a power outlet 26; and controls 28.

The housing 22 has a top 23 with optional edges 25 to allow an open enclave to house the heating elements 24 and allow the heating elements 24 to be exposed. The edges 25 of the housing 22 are preferably at least five inches in height to accommodate the heating elements 24, but can vary according to the type of heating elements. It is contemplated that the width of the housing 22 is approximately the same as the width of the calendar belt 80 since the heat distributed from the pulse heater should be evenly applied to the calendar belt 80. Constructions may vary as to the depth of the housing 22 and, in general, the housing 22 preferably is made of a durable material, such as galvanized steel, that can withstand temperature of at least 650° F., more preferably at least 550° F., and most preferably at least 450° F.

Preferably, the pulse heater 20 is attached directly above the calendar belt 80 at an angle of preferably at least 45° and preferably located at least 7 cm (3 in) away from the calendar belt 80. It is contemplated that the angle and the distance may be more or less depending on the processing equipment and how much heat is required. The pulse heater 20 is preferably located across the entire width of the calendar belt 80 as to distribute heat evenly across such width. However, depending on the equipment, the width of the calendar belt 80 and the type of receiver 40, it is contemplated that the pulse heater can be located closer or further away from the calendar belt 80.

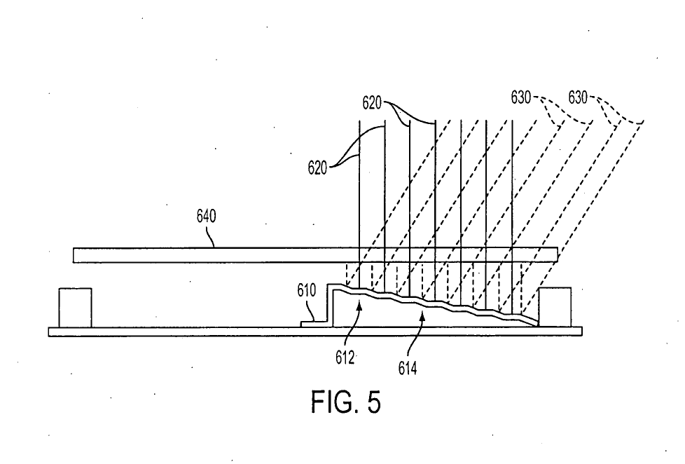

The heating elements 24 preferably can be made from a variety of heat sources, such as overlapping quartz tubes. In a preferred embodiment shown in FIG. 4, the heating elements 24 comprises a series of quartz tubes 500 that can be divided into three zones, 510, 520 and 530 Each quartz tube preferably generates at least 500 watt, or more or less. Depending on the number and positioning of the quartz tubes 500, the power of the quartz tubes 500 can be increased or decreased, such that even quartz tubes generating 1000 watts or more may be used. Each zone (510, 520 and 530) is controlled separately. This enables temperature distribution across belt 80 to be easily controlled by raising and lowering the power output to each zone (510, 520 and 530), and/or by removing one or more quartz tubes from the matrix. It is also contemplated that other types of heat source can be used and a gradient method such is employed. Pulse heat can be generated with any conventional heat source. The heat source can be infrared light, UV light, or any other heat source as long as the source adequately heats up the donor to a temperature that allows the donor to be more readily applied to the receiver.

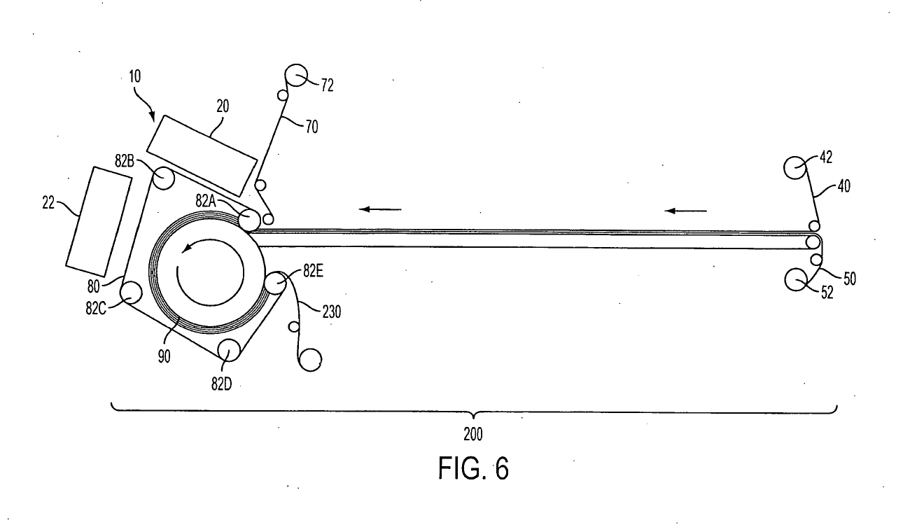

Temperature can also be distributed evenly at the edges of the calendar belt 80 by placing a reflector 610 behind a quartz tube 640, as shown in FIG. 5. Reflector 610 can be angled, but is preferably corrugated, alternating between parallel sections 612 and angled sections 614. Parallel sections 612 reflect heat waves 620 directly towards the belt, and angled sections 614 reflect heat waves 630 towards an edge of the calendar belt 80.

In preferred embodiments, the average temperature applied across the calendar belt 80 from the pulse heater generally varies from 300° F. to 650° F. depending on the properties of the belt, receiver, donor, and dyes used. The weight and density of the receiver, the sublimating temperature of the dye, and the speed of the belt all can be considerations when selecting a temperature. Furthermore, the speed of the belt can greatly influence the size, number, and orientation of the pulse heater(s). The temperature preferably is evenly applied across the width of the calendar belt 80. More preferably the temperature of the calendar belt 80 does not fluctuate more than 35° F., most preferably no more than 25° F.

The dwell time of the pulse heater exposure to the calendar belt is preferably between 10-15 seconds. However, it is contemplated that a slow moving calendar belt might necessitate longer and less intense exposure to a pulse heater, and a fast moving calendar belt might necessitate a short and more intense exposure to a pulse heater.

Controls 28, shown in FIG. 3, can be used to control the temperature, the time, and the type of heat generated by the pulse heater 20. The power outlet 26 and controls 28 can be located as part of existing sublimating equipment or they can be a separate unit depending on the need. Integrating the pulse heater's power outlet and controls with the existing machine allows for a simpler and more uniformed approach. However, providing a separate power outlet and controls can permit the pulse heater to be movable.

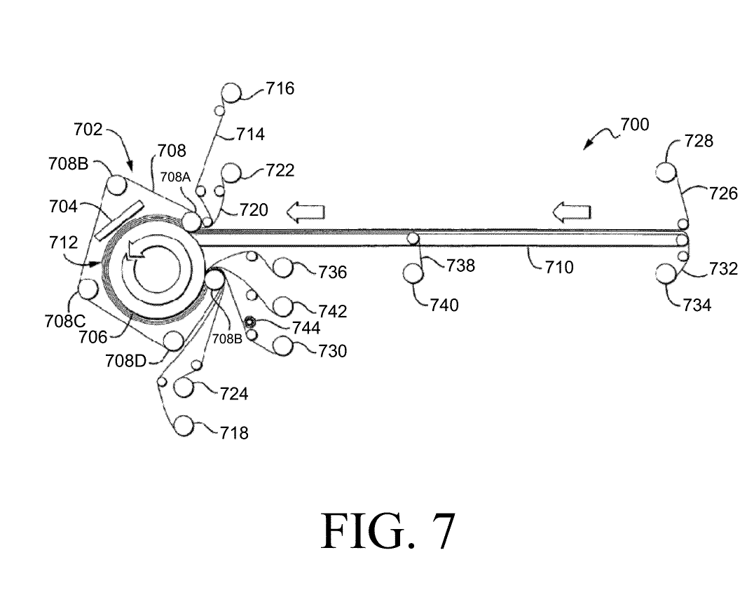

In another preferred embodiment, only one donor (e.g., the first donor 50) is taken up by the belt as shown in FIG. 6. Tissue 70 is needed to protect receiver 40 from being exposed directly to belt 80. Before a tissue-receiver-first donor layered receiver sandwich enters onto the belt 80, pulse heater 20 heats up the calendar belt 80 between positioners 82B and 82A. As the tissue-receiver-donor receiver sandwich enters onto the calendar belt 80, the dissipating heat from the calendar belt 80 causes a phase change on the first donor 50 even though the first donor 50 is against the drum 90. There is enough dissipating heat to cause the phase change for the dyes to penetrate deeper into the receiver 40 to generate a finished receiver 230.

Despite a current preference for continuous processing, it is also contemplated that embodiments of the inventive subject matter could be practiced in a discontinuous manner, for example with sandwiched work pieces being assembled, and heat and pressure applied in a piece by piece manner. In that regard it is specifically contemplated that the receiver could be cut from a bulk material.

A preferred configuration is to construct a pulse heater as a separate piece and attach said pulse heater on to existing cylinder based machines, such as but not limited to Monti Antonio™ Klieverik Heli BV and Practix™ that could be easily modified to operate according to the inventive concepts described herein. Another preferred configuration is to build a cylinder based machine that has a pulse heater constructed within and be integrated into the machine's controls and power system.

The location of the pulse heater can vary according to the need of the finished product. Thus, while it is preferable to have a single pulse heater located between positioners 82B and 82A, it is contemplated that the pulse heater can be located anywhere along the belt to manipulate the saturation and finish of the dyes. Depending on the processing equipment, a pulse heater can be placed either under the calendar belt or over the calendar belt, as long as one side of the belt is being preheated.

It is also preferred to have one or more pulse heaters as shown in FIG. 6. Besides having pulse heater 20 located above belt 80 between positioners 82B and 82A, an additional pulse heater 22 could be located between positioners 82C and 82B can be easily installed. There can be even a pulse heater located between positioners 82C and 82D (not shown). Having one or more pulse heaters can generate more intense heat for a brilliant finish on receivers that would otherwise be difficult to process, i.e. carpet.

The key aspect of the subject matter described herein is that the pulse heater adds additional energy to the kinetic energy already generated from the moving calendar belt to give off an intense yet brief heat. The combination of this heat off the belt and the additional heat generated from the drum will break up the bonds of the donor dyes for a more saturated sublimation process as the sandwiched receiver enters into a rotary heating element. Since the receiver is on the other side of the donor, it is not damaged by the high temperature. When a second donor is placed on the opposite side of the calendar belt where the receiver is, the pulse heater also heats up and prepares the second donor to saturate for deeper dye dispersion and penetration. Thus, it is contemplated that heat sufficient to pulse heat would be applied to two sides of the calendar belt for a length of time that is directly proportional to the length of the belt and the speed at which it operates. The speed preferably depends on the characteristics of the receiver and donor(s). For a more permeable receiver, the speed can be faster and for a less permeable or thicker receiver, a slower process may be needed. Before entering into the rest of the sublimation process, the calendar belt cools down back to normal sublimation temperature. Sublimating heat on any given side is preferably provided for a dwell time of between 15 and 120 seconds, more preferably between 40 and 75 seconds, and most preferably about 45 seconds. Sublimation temperature is preferably no more than 410° F., and more preferably less than 500° F.

Drum 90 provides a consistent heat source that is even around its surface, maintaining a temperature that allows the receiver to better absorb any sublimated dyes from the donor. Preferably, drum 90 is a hot heater drum. It is, however, contemplated that the drum can be any other type of heating unit as long as heat can be applied. Other contemplated examples include a tunnel-shaped heating zone, a heated cylinder, or also by means of a heated plate (iron or warm press).

The temperature generated by the drum to heat the donor is preferably at least 250° F. and more preferably at least 350° F., and most preferably at least 385° F. The temperature differential between the drum where it contacts a donor is preferably 250° F. warmer than the temperature of calendar belt 80, more preferably 150° F. warmer, even more preferably 100° F. warmer, and most preferably 50° F. warmer than calendar belt 80. This temperature differential is adjusted according to the type of donor and/or receiver as well as how the dyes or other type of chemicals on the donor will phase change in order to attach to the receiver.

Tissue 70 can be selected from known take up tissues used in the industry. In contrast to the prior art, the tissues are not used in the current embodiments to absorb dyes that pass entirely through the receiver 40 and opposite donor 50 or 60. That is unnecessary because the donor materials are nearly or entirely impermeable to the passage of dyes. Instead, the tissue 70 in embodiments of the present invention serve to protect the mechanical parts from excess colorant.

First and second donors (50, 60) can be selected from known donor media, such as paper or other materials used in the industry. The donor media can be any thin sheet that is substantially impassible to dye from side to side, but which has a surface to which a dye can be temporarily held. Preferably, a donor is generally an object that holds a dye in solid form that, when a certain amount of heat is applied to the donor, changes phase and travels towards the receiver. Preferably, donors include high energy dyes which provides for more stable and steadfast colors. It should also be appreciated that the terms “dye” and “dyes” are used in the broadest possible sense to include inks, and indeed any chemical composition that can be transferred to a receiver to color the receiver material. Thus, the terms “dye” and “dyes” include chemical compositions that can change color depending upon temperature or other conditions, and even chemical compositions that are colorless when applied, but turn color upon exposure to moisture, or high temperature. Furthermore, the terms “dye” and “dyes” refer to any temperature-sensitive release agent that stains, dyes, or otherwise changes a visual property of the receiver once the dye is heated beyond a temperature threshold. Preferably a dye phase changes from a solid state to a gas state, but a dye can phase change from a solid to a liquid state in certain embodiments.

To that end, the donors (50, 60) can be printed with a solid color pattern (i.e., printed with an identical color covering the entire surface or substantially the entire surface of the receiver), or at least relatively large areas of solid color patterns and/or large repeating patterns. It is especially contemplated that donors 50, 60 can be printed with solids or large repeating patterns having contiguous areas of at least 10 cm2, 50 cm2, 100 cm2, 200 cm2 or 400 cm2. To avoid the color shifts that are prevalent with ink jet and other printed donors, it is preferable when printing solids, or patterns including a single color, to use a roller coater (not shown) to ink one or both of the donors 50, 60. By printing both donors 50, 60 in this manner, receivers can be produced that have the same color of solids on both sides, one color of solid on one side and a different color of solid on the other side, a solid on one side and a pattern on the other, and so forth. Printing patterns on both sides is also entirely feasible, although back-to-back registration of the images is still somewhat problematic. Complex patterns and even photographic or other images can also be printed, with third, fourth, and other colors. Indeed, to simplify the drawing, FIG. 1 should be interpreted generically as including all such combinations.

Receiver 40 can be any material that can receive sublimation printing. This includes most polyesters and other synthetic polymers or fibers that absorb dyes at high temperature and pressure, with currently preferred receiver materials including the true synthetics or other non-cellulosic materials (e.g., polyester, polyimides, polyamides, acrylic, modacrylic, and polyolefin) blends, and so forth. It is contemplated that receiver materials could also include natural fibers (e.g., cotton, wool, silk, linen, hemp, ramie, and jute), semi-synthetics or cellulosic materials (e.g., viscose rayon and cellulose acetate), but currently available colorants do not “take” very well with such fibers. It is further contemplated that temperature influenced receivers such as Tyvek® and others will be available for sublimation using this apparatus. Receivers can be flexible or rigid, bleached or unbleached, white or colored, woven or non-woven, knitted or non-knitted, or any combination of these or other factors. Thus, a receiver could, for example, include a woven material on one side and a non-woven or different woven material on the other side. Among other things, receivers are contemplated to include fabrics and fibers used for clothing, banners, flags, curtains and other wall coverings, and even carpets.

The advantages of the methods and systems disclosed herein are substantial. First of all, by preheating the calendar belt, the sublimation process generally becomes more advanced. The advantage of using the pulse heater allows for greater saturation and use of different dyes. While all sublimation dyes are dispersible, not all dispersed dyes can be sublimated. “Sublimation dyes” are dyes commonly used in the industry that phase change to attach to a receiver at a standard sublimation temperature or sublimate that does not destroy or damage the receiver. In contrast, “high-energy dyes” are dyes which require much higher energy and temperature than standard sublimation temperatures and therefore can destroy or damage the receiver. Thus, high energy dyes could not be used effectively in the past, since the receiver would either be severely burned, melted and reformed into a non-pliable material. The subject matter disclosed herein uses a pulse heater that converts the heat energy and uses it to break the bonds of the high energy dyes and prepares the dispersed side by creating a phase change without transmitting the heat energy to the receiver. Thus, as the sublimation process continues, the high energy dyes are dispersed onto the receiver without producing a higher temperature that can destroy the receiver. The receiver is not damaged by using higher temperature and thus higher energy dyes can be used. This enables the receiver to be ready to receive dyes. Not only will the dyes and prints be more uniformly and consistently applied, they penetrate deeper into the receiver to reduce bleeding or smudging. Overall, the printing and dyeing quality may be significantly improved.

Furthermore, the pulse heater allows for multiple images to go through on the same receiver without significant registering problems. By splitting up the dyeing process into two parts from an instantaneous phase change stage to a gradual absorption stage, the different images or dyes will not bleed or interfere with each other with the pulse heater as the pulse heater preps the receiver more efficiently. Consequently, the pulse heater can also generate double-sided printing that is more uniform and consistent in dye dispersion.

Another advantage of the present inventive subject matter is presented in the convenience and ease of installation. The pulse heater can accommodate a variety of DDS machines. This allows flexibility in not having to replace existing machinery and increase costs. Thus, as the quality improves, the overall production costs do not have to increase.

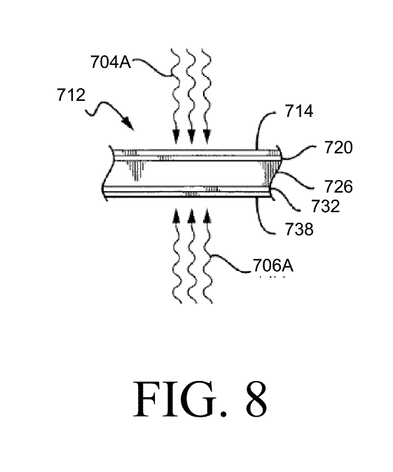

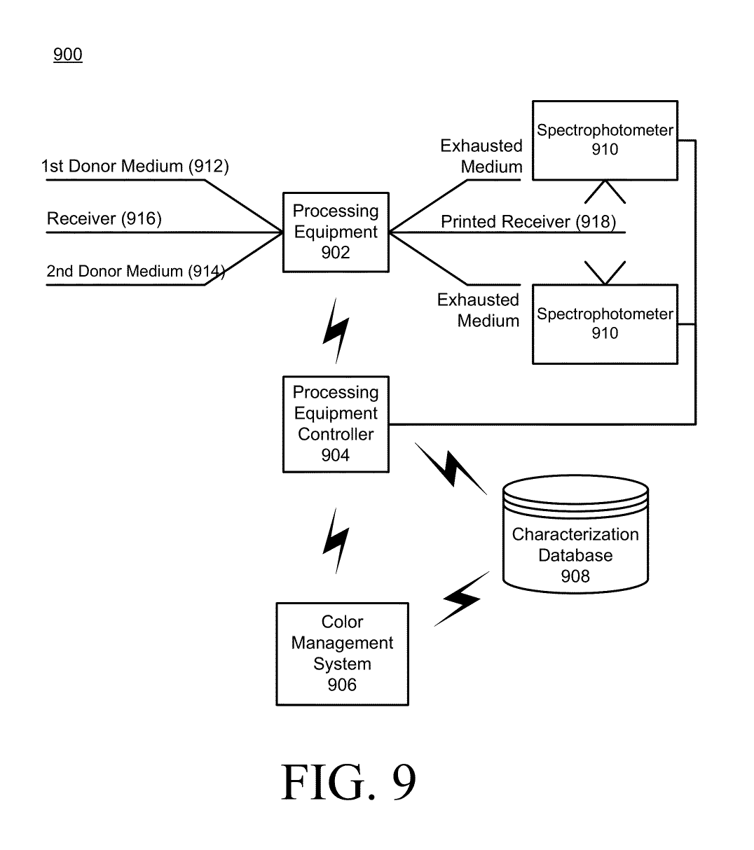

In FIG. 7, processing equipment 700 generally includes a rotary heating portion 702 and a work table 710. Positioned on the processing equipment 700 is a continuous work piece 712 (also shown in FIG. 8) comprising: first tissue 714 with corresponding first tissue feed roll 716 and first tissue take up roll 718; first donor medium 720 with corresponding first donor feed roll 722 and first donor take up roll 724; receiver 726 with corresponding receiver feed roll 728 and receiver take up roll 730; second donor medium 732 with corresponding second donor feed roll 734 and second donor take up roll 736; and second tissue 738 with corresponding second tissue feed roll 740 and second tissue take up roll 742. Also shown in FIG. 7 is a suede brush 744 that restores texture to the receiver 726 after dyeing.

The processing equipment 700 is preferably operated in a continuous manner, and to that end the heating portion 702 preferably includes a rotary primary heating element 704, a fixed secondary heating element 706, and a heat conductive web 708. The web 708 is positioned by positioners 708A-708E. The rotation speed, configuration and dimensions of the heating portion 702 determine the dwell time of sublimating heat upon the sandwiched work piece of first tissue 714, first donor 720, receiver 726, second donor 732, and second tissue 738. Dwell time, temperature, and pressure can be adjusted by a sublimation control system such as that described below. Despite a current preference for continuous processing, it is also contemplated that some implementations could be practiced in a discontinuous manner, for example with sandwiched work pieces being assembled, and heat and pressure applied in a piece by piece manner. In that regard it is specifically contemplated that the receiver could be cut from a bulk material.

There are existing machines (e.g. Monti Antonio™, Practix™ and other cylinder based machines) that could be modified to operate according the implementations described herein. One key aspect is that instead of the previously known configuration in which the work piece (not shown) consists of only a receiver sandwiched between a donor and a tissue, the inventive current work piece 712 comprises a receiver 726 sandwiched between two donors 720, 732, and two tissues 714, 738. Another key aspect is that instead of sublimating heat being applied from a single direction heat source to the donor, to the receiver, and in turn to the tissue, sublimating heat according to present disclosure can be applied simultaneously from both directions (or sides of a work piece). In FIG. 8 this is depicted as primary heat 706A coming from primary heat source 706, and secondary heat 704A emitting from secondary heat source 704.

As discussed above, the term “simultaneously” means that there is at least some temporal overlap. Thus, it is contemplated that heat sufficient to sublimate would be applied from the two sides of the receiver 726 with an overlap of at least 5 seconds, more preferably at least 10 seconds, 20 seconds, 40 seconds, 60 seconds, and most preferably at 80 seconds. Viewed from another perspective, a period of sublimating heat from the second side overlaps with a period of sublimating heat from the first side by at least 5%, more preferably at least 10%, 20%, 40%, 60%, and most preferably at 80%. Sublimating heat on any given side is preferably provided for a dwell time of between 70 and 120 seconds, more preferably between 85 and 95 seconds, and most preferably about 90 seconds. Sublimation temperature is preferably no more than 400° F. (204.4° C.), and more preferably less.

The first and second tissues 714, 738 can be selected from known take up tissues used in the industry. In contrast to the prior art, the tissues are not used in the current embodiments to absorb dyes that pass entirely through the receiver 726 and opposite donor 720 or 732. That is unnecessary because the donor materials are nearly or entirely impermeable to passage of dyes. Instead the tissues 714, 738 in embodiments of the present invention serve to protect the mechanical parts from excess colorant. The first and second donors 720, 732 can be selected from known donor media, such as paper or other materials used in the industry. The donor material can be any thin sheet that is substantially impassible to dye from side to side, but which has a surface to which a dye can be temporarily held. It should also be appreciated that the terms “dye” and “dyes” are used in the broadest possible sense to include inks, and indeed any chemical composition that can be transferred to a receiver to color that receiver material. Thus, the terms “dye” and “dyes” include chemical compositions that can change color depending upon temperature or other conditions, and even chemical compositions that are colorless when applied, but turn color upon exposure to moisture, or high temperature.

To that end, the donors 720, 732 can be printed with solid colors, or at least relatively large areas of solids and/or large repeating patterns. It is especially contemplated that the donors 720, 732 can be printed with solids or large repeating patterns having contiguous areas of at least 10 cm², 50 cm², 100 cm², 200 cm², 400 cm². To avoid the color shifts that are prevalent with ink jet and other printed donors, it is preferable when printing solids, or patterns including a single color, to use a roller coater to ink one or both of the donors 720, 732. Using a roller coater, it is even commercially practicable to print the entire useable area of the receiver with a solid pattern or simple repeating pattern, without visually offensive print lines. By printing both donors 720, 732 in this manner, receivers can be produce that have the same color of solids on both sides, one color of solid on one side and a different color of solid on the other side, a solid on one side and a pattern on the other, and so forth. Printing patterns on both sides is also entirely feasible, although back-to-back registration of the images is still somewhat problematic. Complex patterns and even photographic or other images can also be printed, with third, fourth, and other colors. Indeed, to simplify the drawing, FIG. 7 should be interpreted generically as including all such combinations.

This ability to print an image or light-colored pattern on one side of a fabric, and a different solid and/or large repeating pattern on the other side, is expected to satisfy a very strong unmet need in the market. Ordinary vat dyeing is not commercially viable for this purpose because the process necessarily colors both sides, and adding a pattern onto a surface that already has a color (especially a dark color), results in undesirably murky images and patterns. Thus, a particularly strong application for aspects of the equipment, processes and methods described herein is to provide an image or light-colored pattern on one side of a fabric, and a solid and/or large repeating pattern of a dark or strong color, (e.g., black, blue or red) on the reverse side. In such instances the solid and/or large repeating pattern would preferably comprises a spot color so that it one can reproduce the color at will according to its digital value. But one could alternatively employ the four primary colors, one of the twenty-four secondary colors, or any other color.

The receiver 726 can be any material that can receive sublimation printing. This includes most especially polyesters and other synthetic polymers that absorb dyes at high temperature and pressure, with currently preferred receiver materials including the true synthetics or non-cellulosics (e.g., polyester, nylon, acrylic, modacrylic, and polyolefin), blends, and so forth. It is contemplated that receiver materials could also include natural fibers (e.g., cotton, wool, silk, linen, hemp, ramie, and jute), semi-synthetics or cellulosic materials (e.g., viscose rayon and cellulose acetate), but currently available colorants do not “take” very well with such fibers. Receivers can be flexible or rigid, bleached or unbleached, white or colored, woven, non-woven, knitted or non-knitted, or any combination of these or other factors. Thus, a receiver could, for example, include a woven material on one side and a non-woven or different woven material on the other side. Among other things, receivers are contemplated to include fabrics and fibers used for clothing, banners, flags, curtains and other wall coverings, and even carpets.

In some implementations, a receiver 726 can be placed between a top donor 720 and a bottom donor 732 as in FIG. 7, and a piece donor (not shown) can be placed between the top donor 720 and the receiver 726, and inserted prior to passing through optional rollers (not shown on FIG. 7). The piece donor can block transfer of dye from the top donor 720 to the receiver 726 over the entire surface of the piece donor, while at the same time allowing transfer of the remaining area of top donor 720 onto receiver 726. This operation effectively makes a composite transfer consisting of solid or other background from the top donor 720, and a perfectly fit image or solid from the piece donor. The piece donor could, of course, have different shapes from that shown, including for example complex shapes such as dragons or even doilies.

As used herein, the terms “article” and “articles” refer to textiles, clothing, carpets and other items that are thought of as three dimensional, as opposed to paper which is sufficiently thin to be thought of as being substantially two dimensional. Various types of useful articles of manufacture can be printed as described herein.

The advantages of the methods and systems disclosed herein are enormous. For the first time, a manufacturer can fulfill small orders with almost perfect color consistency, in a commercially viable manner. Thus, a furniture store need not run large quantities of upholstery fabric to maintain color consistency from one month to the next, or even from one year to the next. Similarly, a shirt manufacturer can accurately produce the same color background on a T-shirt whether he is manufacturing 100,000 shirts, or 100 shirts one day and 100 shirts a month later. This flexibility can provide, perhaps for the first time, a commercially viable system and method of sourcing, producing, and marketing clothing in which the fabric is colored on an as needed basis and even on-site at a cut-and-sew facility, with a guaranteed color consistency. Those skilled in the art will appreciate that the inventive subject matter can be applied to any colored material, including clothes, handbags and other accessories, furniture, fabrics to cover non-furniture spaces in automobiles and other motor vehicles carpets, powder coated metals, plastics and so forth.

It is particularly contemplated that the teachings herein can be used to source “just in time” or small lot printing of any of these articles, which has heretofore been a practical impossibility. For example, small lots of an article can be practically printed and sourced even though the lots are no more than 5000, 1000, 100 or even 50 pieces, or from another perspective no more than 5000, 1000, 100 or even 50 meters of material.

Quite surprisingly, all of this can be accomplished with excellent color saturation and consistency, even where different colors are applied to different sides of the fabric. Thus, using the parameters set forth herein, a shirt fabric can be digitally dyed with red on one side and blue on the other, or with one side a full color image on a blue back ground, and the other side being uniformly black. This ability to maintain color consistency to even small digitally detectable differences is the root of the term digital dyeing. Those skilled in the art will appreciate that this level of color consistency between commercial lots is just unheard of with prior art dyeing techniques.

It is also surprising that methods according to the present invention can be sufficiently rapid to compete with other dyeing techniques. For example, in a method of dyeing sections of a continuous recipient, wherein dye from rolls of donor media such as paper or other sheeted material is sublimated into a recipient in adjacent sections, speeds of at least 95, 150, 200, 250, 300, 500, and 900 meters per hour can be achieved. Indeed, since dyes can be sublimated into both sides of a fabric simultaneously, these speeds can even be achieved dyeing different colors on the two sides. Still further, using intermediate donor sheets between the recipient and an overlying donor sheet, these same speeds can be achieved when transferring an image (full color or otherwise) into the recipient while simultaneously printing a solid background around the image.

Another advantage is that the digital dyeing process (e.g., simultaneous multiple sided dye sublimation printing as described herein) can produce solid colors on both sides of a fabric or other material, with a consistency that previously could only be achieved with immersion dyeing. However, the dye sublimation process as described herein may not have any excess dye and carrier fluid to release into the environment. As a result, the teachings herein can now make it commercially practicable for purchase orders for such small lots to specify delivery windows for “to be” printed materials that are effectively no more than 30, 14, 7, or even one or two calendar days. Still further, the printing can take place in the United States of America or other countries that ban commercial facilities releasing large quantities of dyes into the environment.

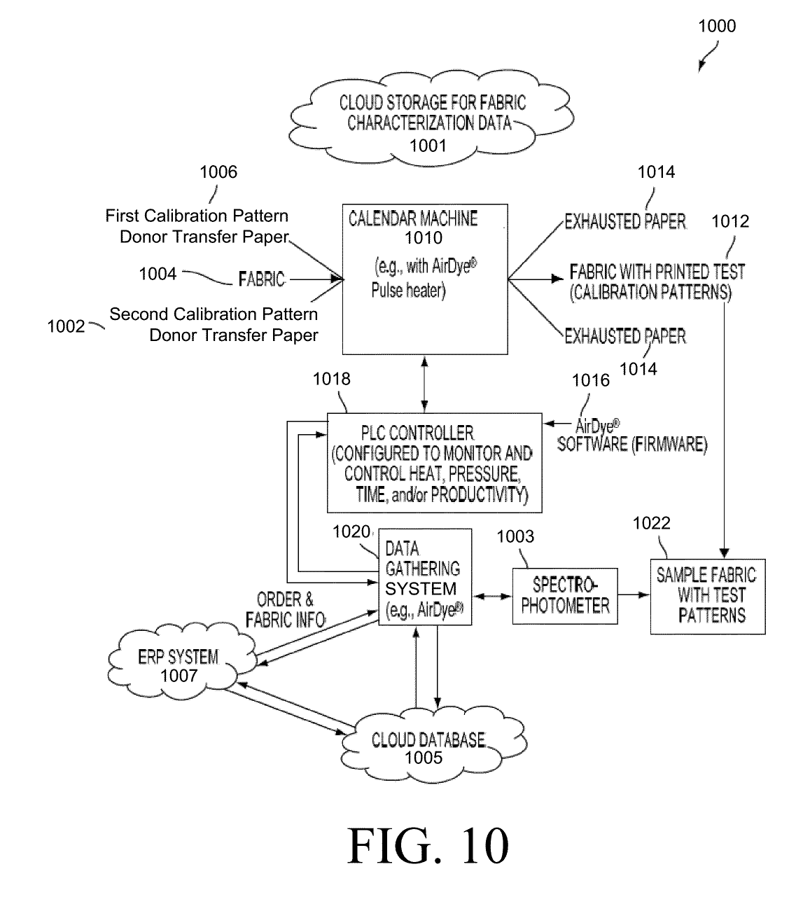

FIGS. 9-12 provide block diagrams depicting example sublimation process control systems and environments. The processing systems and environments can include one or more pieces of sublimation processing equipment, which can include calendar machines.

FIG. 9 shows an example sublimation process environment 900 that includes processing equipment 902, a processing equipment controller 904, a color management system 906, a characterization database 908, and one or more spectrophotometers 910. The processing equipment 902 can include a DDS calendar machine, a DDS calendar machine having a pulse heater, a stationary DDS printer, or the like. The processing equipment controller 904 can include a computing system, a programmable logic controller or the like. It will be appreciated that the processing equipment 902, the processing equipment controller 904 and the color managements system 906 can be separate systems or components, or two or more of the above can be integrated. For example, the processing equipment 902 can include an integrated processing equipment controller 904 and/or color management system 906.

In operation, the color management system 906 can send a print job file giving information about an order to be printed to the processing equipment controller 904. The print job file can include one or more image reference values generated at the color management system 906 or received at the color management system 906 from a source external to the color management system 906 (e.g., an external customer system). For purposes of illustration, the print job file may contain two image reference values, Image A Ref and Image B Ref corresponding to two images to be printed on a given receiver 916 (e.g., a fabric substrate). It will be appreciated that a single image may be printed in a single-sided DDS process using the processing equipment 902. The print job file can include other conventional DDS printing parameters such a type of receiver material, length of print run, offset parameters, etc. In addition to the two image references and the conventional printing parameters, the print job file can include processing equipment control values (or a reference value providing the location of a processing equipment control value file located elsewhere, such as the characterization database 908).

The processing equipment control values can include one or more temperatures (e.g., a temperature for the drum and calendar belt of the processing equipment 902), one or more pressures (e.g., a pressure of the calendar belt against the drum of the processing equipment 902), and a time value representing an amount of time that the receiver material is to be exposed to the temperature and pressure of the processing equipment 902. The time value can include an actual time value (e.g., a number of seconds) or a speed of movement of the receiver 916 through the processing equipment 902 (e.g., a value expressed in terms of meters per second).

The processing equipment control values can be based on characterization data characterizing the given processing equipment 902, the receiver 916 material, characteristics of the images (e.g., colors used, whether one or more of the images are a solid image, etc.), or a combination of two or more of the above. The characterization data can be retrieved by the color managements system 906 from the characterization database 908 (and sent to the processing equipment controller 904 from the color management system 906), or retrieved by the processing equipment controller 904 from the characterization database 908. The characterization data can be generated via a process described below in connection with FIG. 12.

In this example of a double-sided DDS printing process, the example donor transfer media is paper and two donor transfer papers are loaded. The two donor papers include a first donor transfer paper 912 that corresponds to Image A Ref and a second donor transfer paper 914 that corresponds to Image B Ref. The donor transfer papers can be identified using a computer readable indicium (and/or human readable indicium) disposed on the donor transfer paper, where the computer readable indicium corresponds to an image reference value. The indicium can be used to verify that correct donor transfer papers are being used for a current print job. For example each roll (or sheet) of donor transfer paper having an image applied may also include a computer readable indicium disposed on the roll or sheet (e.g., printed near an edge of the roll or sheet, printed on a back side of the roll or sheet, applied as a sticker to the roll or sheet, etc.) that corresponds to an image reference value. The computer readable indicium can include one or more indicia such as 1-D, 2-D, or 3-D bar codes, QR code or the like. The computer-readable indicium may be scanned into the processing equipment controller 904 or the processing equipment 902 using known image acquisition techniques such as bar code scanning, QR code scanning or the like. In some implementations, there may be a human readable indicium (e.g., a printed alphanumeric identifier) on the roll or sheet of donor transfer paper that an operator can read and enter into the processing equipment controller 904 or the processing equipment 902. By receiving computer and/or human readable indicia on the donor transfer paper rolls or sheets, the processing equipment 902 (or processing equipment controller 904) can determine if the donor transfer papers being loaded onto the processing equipment 902 for processing contain the images specified in the print job file currently being processed.

The receiver 916 is also loaded for processing. The receiver 916 may have a machine-readable and/or human-readable indicium applied, which may be scanned (or read) and verified in a manner similar to that discussed above for the donor transfer paper indicia. In addition to indicia printed for the purpose of identifying donor transfer papers and/or receiver materials, it is contemplated that a system could be configured with an image acquisition device (e.g., digital camera) and image processing software configured to identify the donor transfer paper and/or receiver material using known image processing and object recognition techniques.

Once the donor transfer papers 912, 914 and receiver 916 are loaded, the processing equipment 902 can process the donor transfer papers 912, 914 and receiver 916 according to the processing equipment control values received from the processing equipment controller 904. The processing equipment 902 generates a printed receiver 918 and exhausted donor transfer paper. Over time (e.g., during a print run or in between print runs), the processing equipment 902 and/or the environment surrounding the processing equipment 902 may change. These changes may alter the appearance of the printed receiver 918.

From time to time, the processing equipment controller 904 may utilize a spectrophotometer 910 to obtain spectral information from one or both sides of the printed receiver 918. The obtained spectral information may be compared to desired output spectral information. If a result of the comparison is above a given threshold, the processing equipment controller 904 may adjust one or more of the processing equipment control values in order to obtain desired spectral values in the printed receiver 918. For example if a color on one or both sides of the printed receiver is compared to desired output colors and a result of the comparison exceeds a threshold value, the processing equipment control values may be adjusted to cause the processing equipment 902 to produce a printed receiver having one or more colors that, when compared to the desired output colors, do not exceed the threshold value.

The processing equipment characterization data can be used in the adjustment of the processing equipment control values. For example, the processing equipment characterization data can include information about what spectral effects in the printed receiver result from changes in the processing equipment control values. This information can be used to interpolate or infer changes in the processing equipment control values that will results in desired spectral qualities of the printed receiver 918.

FIG. 10 is a diagram of an example sublimation process environment 1000 configured for characterizing a given receiver (e.g., fabric 1004) and a given processing machine (e.g., calendar machine 1010). The environment 1000 includes a cloud storage for fabric (and sublimation processing equipment) characterization data 1001, a calendar machine 1010, a PLC controller 1018, data gathering system 1020, an enterprise resource planning (ERP) system 1007 a cloud database 1005 and a spectrophotometer 1003.

In an example fabric/machine calibration process, a first calibration pattern donor transfer medium 1006, a fabric 1004 receiver, and a second calibration pattern donor transfer medium 1002 are loaded for processing according to the recommended procedure for the calendar machine 1010. The PLC controller 1018 executes a set of software (or firmware) instructions 1016 and commands the calendar machine 1010 to begin processing the first calibration pattern donor transfer medium 1006, the fabric 1004 receiver, and the second calibration pattern donor transfer medium 1002 according to an initial calendar machine control parameter set. The calendar machine control parameter set including one or more temperature settings, a pressure setting and a time setting. As the calendar machine 1010 processes the first calibration pattern donor transfer medium 1006, the fabric 1004 receiver, and the second calibration pattern donor transfer medium 1002, the calendar machine 1010 produces printed fabric 1012 and exhausted donor transfer media 1014. The printed fabric 1012 includes a first calibration image from the first calibration donor transfer medium 1006 on a first side of the fabric 1012 and a second calibration image from the second calibration donor transfer medium 1002 on a second side of the fabric 1012.

A sample of the fabric with test patterns 1022 can be obtained from the printed fabric 1012. Both sides of the sample 1022 can be measured with a spectrophotometer 1003 to obtain spectral measurement data from both sides of the sample 1022. The spectral measurement data can be transmitted to the data gathering system 1020. The data gathering system 1020 can use the spectral measurement data to generate a characterization of the fabric 1004 and the calendar machine 1010. The sample can be from a portion of the printed fabric 1012 printed using a given calendar machine parameter set. Additional samples can be obtained from portions of the printed fabric printed using different calendar machine parameter settings and measured using the spectrophotometer 1003. In addition to the reflectance measurement data, other characterization data can be obtained, as described below in connection with FIG. 12.

The ERP system 1007 can transmit order information (e.g., print job files, donor transfer media image references, etc.) and fabric information (e.g., type of fabric to be processed and fabric characterization information) to the data gathering system 1020, which, in turn, can transmit data to the PLC controller 1018 to execute the print job according to the information received from the ERP system 1007. The ERP system 1007 can be configured to help ensure production color consistency through planning and optimizing the production capacity of one or more networked calendar machines. Also, importantly, the ERP system 1007 can be configured to be a cloud-based system (e.g., built using cloud computing processing and memory resources) to manage color integrity across the networked calendar machines. In some implementations, color management as described above can include the use of a computer readable indicium such as a QR code that accompanies each roll of donor transfer media with respect to a customer order (e.g., printed near an edge of the roll or sheet, printed on a back side of the roll or sheet, applied as a sticker to the roll or sheet, etc.). Information from these QR codes can be exchanged with the ERP system 1007 database on fabric characterization and used to retrieve the appropriate calendar operation parameters for the calendaring process. In addition, there can be a set of control color blocks at the side of each roll of donor transfer media to be measured for spectral reflectance data by the spectrophotometer after the calendaring process. This spectral measurement can be fed back to the ERP color management system 1007 to manage the color integrity across the supply chain in terms of accurate color matching and optimal color reproduction among the networked calendar machines.

The ERP system 1007 can also be configured to perform functions such as logistics, procurement, distribution, and/or customer and sales service. For example, by having information indicating the available production capacity of each calendar machine across the network of machines in communication with the ERP system 1007, the real time raw materials inventory and the customer demand status at multiple geographical locations, the ERP system 1007 can maximize the various logistics processes to direct the “traffic” of the calendaring production sites to balance the supply and demand based on the best of production and market intelligence from the ERP system 1007.

Some implementations, can overcome problems and complexities associated with existing processes by building and using a calendar machine that is specifically designed for a double sided heat transfer process, such as, for example, the AirDye® double sided heat transfer process. This calendar machine, as opposed to being manually set and controlled, can be totally configured and controlled by a computing device (e.g., a PLC). Calendar machine 1010 can be configured and controlled by the PLC controller 1018. The PLC controller 1018 can be connected to the Internet and ultimately to a fabric characterization database such as the fabric characterization database 1005, the cloud storage 1001, the ERP system 1007, and/or the cloud database 1005. In the example of FIG. 10, the PLC controller 1018 can be configured to monitor and control heat, pressure, time, and/or productivity of calendar machine 1010. In an embodiment, fabric characterization database 1005 can be stored in cloud storage 1001. For example, the controller 1018 can be configured to collect and monitor calendar machine operating parameters via different types of sensors during the processing operation in order to compare the collected data with corresponding standard data to make a system decision as to whether action(s) is/are needed by the controller 1018 to vary the levels of the parameters to correct operational parameter error(s). The parameters include: temperature of the heat transfer process at the calendar drum surface, the blanket surface directly under the pulse heater, and the blanket temperature at the nip; timing of heat transfer process by speed control of the calendar drum; pressure of the heat transfer process (e.g., nip pressure) by controlling the air pressure that adjust the blanket tension; and productivity. Productivity of the calendar machine can be affected by changing the level(s) of any combination of these temperature/timing/pressure parameters, which can change the production speed or productivity of the calendar machine. However, incorrect changes on the level(s) can result in poor color consistency/color reproduction, hence the importance of the color management system.

As mentioned above, the processing equipment control parameter values can include one or more temperatures (e.g., a temperature for the drum and calendar belt facing the pulse heater of the processing equipment), one or more pressures (e.g., a pressure of the calendar belt against the drum of the processing equipment), and a time value representing an amount of time that the receiver material is to be exposed to the temperature and pressure of the processing equipment. For example, a typical standard drum temperature range and the dwell timing range are 375-385° F. and 45-60 seconds, though this temperature can vary up to 30° F. in either direction and by 30 seconds dwell time in either direction as well.

The control parameters can have an impact on the color and physical fabric properties as described below. The temperature can affect the color quality in terms of color strength and shade as well as fabric handle. A temperature that is too high can be detrimental to the handle of fabric. As the temperature is increasing, the color strength and its penetration normally increases while its hue can also shift depending on the unique sublimation curves of each of the dyes. A sublimation curve plots the strength of the color on the fabric as it is exposed to changes in the time, temperature, and pressure. Further, an increase in temperature may render the fabric handle unacceptable. On decreasing the temperature, the fabric handle is normally improved while the color strength becomes weaker and its hue may shift. This decrease in temperature may also change the penetration of the dyes through the fabric and therefore the subsequent color on the opposite side of the fabric.

The dwell time can affect the color quality in terms of color strength and shade as well as fabric handle. It can be detrimental to the color quality when the dwell time is wrong. The pressure primarily affects the fabric handle and the color penetration through fabric. The changing pressure may also cause fabric wrinkling problems especially for knit and light weight fabrics.

As discussed above, the different controllable parameters may influence the desired properties of the final fabric. This interrelationship between processing parameters and properties of the finished product can make the control and operation of this process very difficult.

Through a connection to cloud database 1005 and cloud storage 1001, an operator is able to download to the calendar machine 1010, order-specific information that would be necessary for the initial configuration of the calendar machine 1010. This information can come from a database that is generated during the fabric characterization process and stored in cloud storage 1001. This information could be delivered to the calendar machine 1010 on either a fabric or an order basis depending on the final need of the calendar machine 1010. In an embodiment, the database can be implemented as a SQL server database that is configured to push out PLC instructions to one or more client/subscriber PLC controllers. In the example shown in FIG. 10, calendar machine 1010 is the client, and the owner of calendar machine 1010 is a subscriber (e.g., a customer or licensee).

The systems shown in FIGS. 9-12 are dynamic in that they calibrate the calendar machine (e.g., machine 902 or 1010) and monitor the machine as it is running, in near real-time. The PLC control provided by PLC controller 1018 can further monitor the conditions of the calendar machine 1010 during the production of the order and make any necessary alterations to the settings of the machine regarding speed, temperature, and/or pressure. As seen in FIG. 10, PLC controller 1018 can also send data at regular intervals back to the cloud database 1005 for storage for subsequent qualification of the calendar machine 1010 during production for claim and quality analysis.

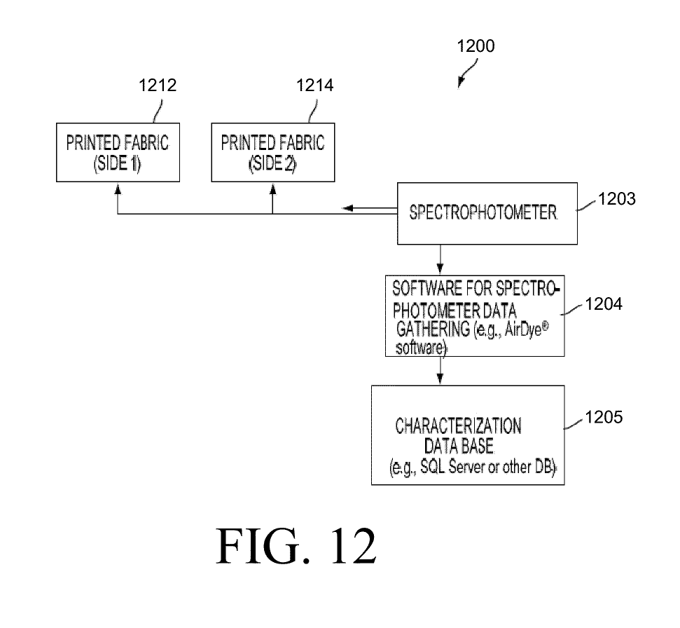

By implementing computerized control of the calendar machine (e.g., via a PLC), the example systems shown in FIGS. 9-12 help provide “smart” processes based on objectively acquired and accurate data done within a controlled environment. This provides for an easy integration of this process with minimal operator training as well as quickly expediting the ability to globalize double sided heat transfer processes, such as, for example, the AirDye® double sided heat transfer process. Some implementations facilitate ease of use for operators without requiring technical expertise/training, while providing consistent results. That is, some implementations enable the same product to be generated even when multiple plants are used in disparate locations (e.g., as shown in FIG. 11), while also minimizing waste.

Another aspect of some implementations for the control and globalization of double-sided heat transfer processes is the management of the calendar machine as the machine ages. In some implementations, the ability to maintain the temperature, time, and pressure of the machine 1010 are all controllable by the PLC controller 1018 and the information that is gathered and stored in a database. In some implementations, the database can be a fabric characterization database stored in cloud storage 1001. As machine 1010 changes (e.g., due to age or changing conditions in the field), data previously stored in the database that worked under certain conditions can be changed to reflect the changed machine conditions. This updated data can be fed from PLC controller 1018 back into the fabric characterization database, and then data in the fabric characterization database can compensate for changes. In this way, the PLC controller 1018 can adjust machine 1010 via new, and/or updated/modified PLC instructions. Machine adjustments can compensate for changed conditions, such as, for example, humidity and temperature changes at a plant.

As a calendar machine such as machine 1010 is used, the “blanket” (or calendar belt) of the machine can age. The blanket of a calendar machine can be used to maintain intimate contact of the donor transfer media with the receiver (e.g., fabric) against the heated blanket and the drum. The blanket of the machine is considered a consumable item because of this aging process. As the blanket ages, it will change the final appearance of the product unless the settable parameters of the calendar machine are changed to compensate for this aging. Under normal circumstances, this would negate our ability to use the characterization information in the fabric characterization database for all but initial, first-time installations having new blankets that have not aged. To alleviate this issue, some implementations standardize the calendar machine to a baseline position as the blanket ages. These implementations can include baselining the machine, and a fabric characterization database can request baseline data from the PLC. At this point, the fabric characterization database can push back modified instructions to the PLC. This is akin to recalibration.

During a heat transfer operation such as dye sublimation transfer, there are a number of possible causes for process drifts that need to be controlled and adapted for. Some causes of process drift can be minimized through machine maintenance while others are typically managed through operational process changes. The causes of process drift listed below may require an adjustment of the machine parameters related to one or more of time, temperature, and pressure to help ensure that the final product produced by the process (e.g., dye sublimation printed fabric) will meet all of the required color and physical properties that a customer has dictated.

Cause for process drift include the following:

a) machine belt aging—this is the deterioration of the calendar belt/blanket as it ages.

b) oil deterioration—this is the drum oil deterioration that includes scale build up inside the calendar drum, which can change heat conductivity of the drum.

c) environment humidity and temperature—when the humidity and the temperature of the operation environment changes, the process drifts.

d) heat sinking—increasing fabric and transfer media thickness/weight may create a “heat sinking” effect and impact on the heat transfer process quality.

e) textile receiver—lot to lot inconsistency because of fiber, yarn and fabric weaving/preparation processing variations.

In some implementations, it may be beneficial to conduct a calendar baselining operation using a standard fabric (e.g., polyester pongee) and a given calendar machine as described in the following steps.

1. Prepare and provide a consistent test strip having consistent color blocks.

2. Subject the test strip to normal baseline calendar control parameter values.

3. Measure, with a spectrophotometer, the spectral and colorimetric values of each color block after the test strip is heat transferred to the production fabric.

4. Compare the measured values for each color block with its corresponding reference values.

5. The ERP color management system (or other similar system) analyzes the result of the comparison and repeat steps (1) to (4), if needed, using a set of corrected control parameter values.

6. The corrected control parameter values are verified to be acceptable when the measured values for each color block when compare to its corresponding reference values are acceptable. Otherwise, it may be necessary to repeat steps (1) to (6) again.

According to some implementations, machine baselining can be accomplished through the use of a test strip that is provided. The test strip can be produced under controlled printing conditions. This test strip can be processed on calendar machine 1010 at an end user's location, and the results can be read objectively with a spectrophotometer (e.g., spectrophotometer 1003 of FIG. 10). This control strip can have various patches of controlled colors on it and the results of this strip would be specific to each strip. The results would be read into the data gathering system 1020, which would then interpret these results and alter the baseline setting of the machine so that the required results could be obtained. The user can then produce a second (repeat) of the process and verify that the results are correct prior to proceeding. The PLC controller 1018 would then recognize this new baseline configuration and modify all data received from the fabric characterization database based on this new baseline. This would then assure that all production on a machine was maintained to proper quality and consistency as the blanket ages. By monitoring the blanket aging process, the PLC controller 1018 would also notify the user of the machine 1010 as the blanket was reaching its maximum age and therefore ready for replacement. The PLC controller 1018 could also easily prevent the machine 1010 from being used if the blanket was aged beyond adjustment or if the machine 1010 is being used beyond tolerance based on feedback information to the cloud database 1005.

FIG. 11 shows a diagram of an example sublimation environment 1100 having a plurality of sublimation processing machines (1114-1118). In the environment 1100, an order 1102 is received by a control system 1104 (e.g., processing equipment controller 904, data gathering software 1020). The order 1102 can include print job instructions specifying a receiver fabric type, one or more donor transfer media image references, etc.

The control system 1104 can determine whether the order 1102 would require more than one sublimation processing machine in order to process the order (e.g., based on machine capacity, date finished order needed, etc.). When more than one sublimation processing machine is needed, the control system 1104 can communicate with a plurality of sublimation processing machines (1114-1118) via network 1106 and send order information tailored for each sublimation processing machine. The order information for each sublimation processing machine can include control settings (1108-1112) for each sublimation processing machine based on characterization information for the fabric to be printed and the respective sublimation processing machine. The characterization information can be obtained from a database (e.g., 908, 1001, and/or 1005).

Using the control settings (1108-1112), each respective sublimation processing machine (1114-1118) can produce finished products (1120-1124) (e.g., printed fabric) having the same or nearly the same spectral properties even though the sublimation processing machines (1114-1118) may be of different types, different ages, located in different places, and/or be operated by different operators. The control system 1104 and control settings based on fabric/machine characterization serve to reduce or eliminate the effects of the various differences that can exist among a group of sublimation processing machines (1114-1118).

To maintain finished products having the same or nearly the same spectral properties over time, spectrophotometers (1126-1130) can be used to obtain spectral measurements of the respective finished products (1120-1124). The spectral measurement data can be provided to the control system 1104, which can then adjust the control settings (1108-1112) for each respective machine as needed and provide updated control settings (1108-1112) as needed.

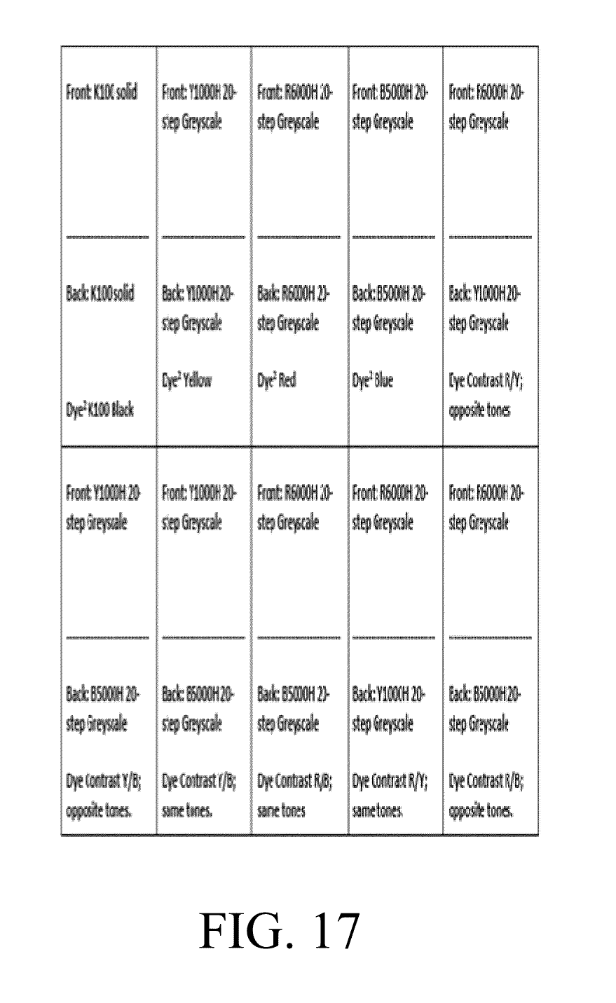

As discussed herein, an initial fabric characterization can be used to set values of control parameters for a particular calendar machine when printing on a given receiver substrate (e.g., fabric). In the initial fabric characterization, a specific production fabric is printed with a specific image template (see, e.g., FIGS. 16 and 17, and their corresponding description below) in a specific calendar machine on a single or double side of the same fabric using a permutation of an earlier reported setting of control parameter values (e.g., temperature, dwell time, and pressure). For example, for each permutation of control parameter values (e.g., 380° F./40 seconds/40 psi), the image template is transferred, using this condition, first on fabric front only, second on fabric back only and third on both front and back of the fabric producing a total of three pieces of transferred/printed fabric. The results of the transferred image template are objectively measured and tested for performance and dye acceptance. The printed fabric objective tests include the following:

1) Fabric handle test, which measures whether the hand/feel of the fabric is acceptable. The fabric handle test may be performed by a Handle-O-Meter, manufactured by Thwing-Albert, or other similar device for measuring the hand of fabric (e.g., the combination of surface friction and flexibility of sheeted materials).

2) Dye uptake test, which measures the level of color strength (e.g., on the three pieces of transferred fabric. The level of color strength can be measured with a spectrophotometer.

3) Seam quality test, which can verify that colorant penetration of fabric is achieved for sewn garments such that little or no white fiber is revealed after the sewing process. Computer imaging systems can be used to perform the seam quality test.

4) Wet and dry crock measurement of how much dye will rub off from a fabric when the fabric is wet and dry, respectively. Dry crock can often be a more important measurement for most apparel, while wet crock can be more important for certain fabrics and applications, such as, for example, bathing suits, towels, and outdoor furniture fabric.

In addition, it can be useful to identify the front and back of the fabric for these tests and its orientation at the heat transfer process.

It is important to note that successful objective tests using the above four methods may be a pre-requisite for adoption of each permutation of control parameter value combination for use with a color management application. Other tests such as color fastness to light, color fastness to washing, sewing quality, air permeability and others may also be included but may be of secondary importance in some instances.

By performing the fabric characterization process described above and in detail below, a fabric characterization database can be developed that potentially includes a large number of permutations of successful control parameters combinations and corresponding color measurement data for an individual color block of a template image for a given fabric and a given calendar machine. Data analysis of the deviation of the captured data at the completion of calendar baselining/characterization operation from the corresponding cloud stored standard values can permit determination of further correction in terms of values for temperature, pressure, and timing for the calendaring process. Such correction information (e.g., in the form of one or more adjusted parameters) is transmitted electronically to the calendaring machine (or calendar machine control system) to cause an automatic change in the calendar machine settings to render an optimal (or near optimal) calendaring result in terms of color repeatability and reproducibility.

The workflow 1200 of FIG. 12 includes using a spectrophotometer 1203 to measure spectral values of printed test patterns on both sides 1212 and 1214 of the printed fabric 1012, and profiling, based at least in part on the measuring, how sides 1212 and 1214 of the printed fabric 1012 absorbs dyes. Workflow 1200 can include gathering and saving measurement and profile information in a fabric characterization database 1205, and then varying the variables (e.g., varying one or more of the process equipment or calendar machine control parameters) and repeating the printing of the calibration patterns on fabric as described above in relation to FIG. 10 and repeating the process of FIG. 12 for receiving of the variables, the producing, the measuring, the profiling, and the saving until a given number of permutations are met. The data gathered during the permutations can be used to characterize a particular fabric/machine combination. The characterization of the fabric/machine combination can be stored in a characterization database and used for any print jobs having the same (or similar) fabric/machine combination. A similar fabric/machine combination can be determined for example when a fabric is being used that is similar in composition to a fabric that has already been characterized. Also, a similar fabric/machine combination can be determined when a given fabric is used on a machine that is similar (e.g., same make, model, age, and/or environment, etc.) to a machine that has already been characterized for that fabric.

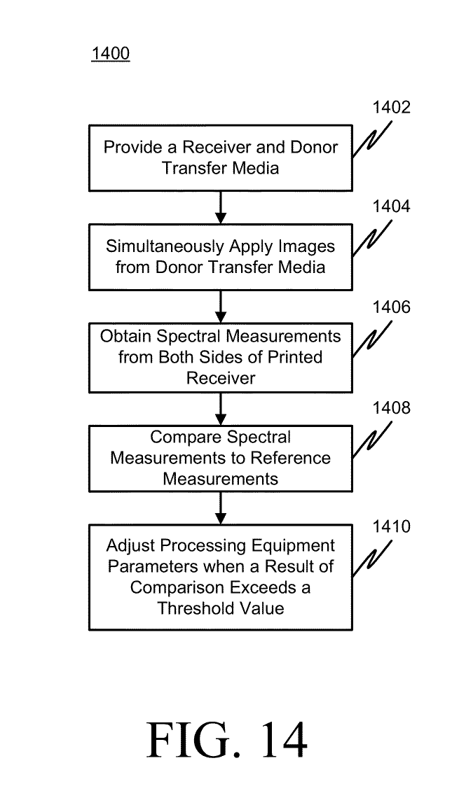

FIG. 13 is a flow chart of an example method for sublimation characterization in accordance with at least one implementation. Processing begins at 1302, where a receiver (e.g., a substrate such as fabric) and characterization donor media (e.g., two donor transfer papers) are provided and loaded into a sublimation processing machine. For example, 1004, 1006, and 1002 of FIG. 10 are provided and loaded into a calendar machine 1010. Processing continues to 1304.

At 1304, an image from each donor medium is simultaneously transferred to a respective side of the receiver using the sublimation processing machine (e.g., 1010) as described above. Processing continues to 1306.

At 1306, one or more processing equipment control parameters are varied. For example, a temperature value, time value and/or pressure value is varied and the changed control parameter(s) are sent to the sublimation processing machine from a controller (e.g., parameters are sent to calendar machine 1010 from PLC controller 1018). Optionally, step 1304 is repeated for each variation in control parameters. Once the printing is complete, processing continues to 1308.

At 1308, spectral measurements are obtained from both sides of the printed receiver (e.g., using spectrophotometer 1003). The spectral measurements can include reflectance data that can indicate the color or colors printed on the receiver. Processing continues to 1310.

At 1310, characterization data based, at least in part, on the spectral measurement data is stored (e.g., in a characterization database).

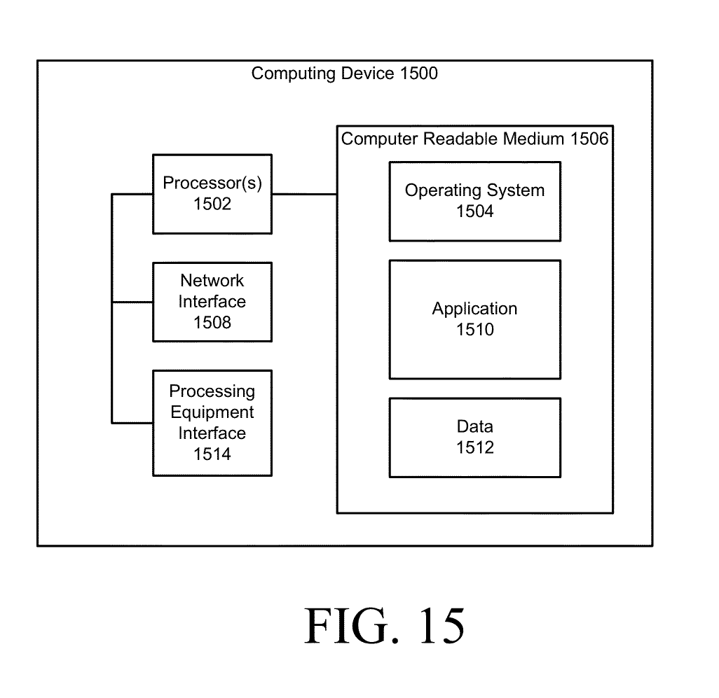

FIG. 14 is a flow chart of an example method for sublimation processing equipment control in accordance with at least one implementation. The method begins at 1402, where a receiver (e.g., a substrate such as fabric) and characterization donor media (e.g., one or two donor transfer papers) are provided and loaded into a sublimation processing machine. For example, 1004, 1006, and 1002 of FIG. 10 are provided and loaded into a calendar machine 1010. In another example, 916, 912 and 914 are loaded into processing equipment 902 of FIG. 9. The method continues to 1404.

At 1404, images from the donor transfer media (e.g., 912/914, 1006/1002) are transferred onto the receiver (e.g., 916, 1004) in the sublimation processing machine (e.g., 902, 1010). The method continues to 1406.

At 1406, spectral measurements are obtained from both sides of the printed receiver (e.g., using spectrophotometer 910 or 1003). The spectral measurements can include reflectance data that can indicate characteristics of the color or colors printed on the receiver. The method continues to 1408.

At 1408, the spectral measurements are compared to reference measurements (e.g., compared to measurements of a desired printed receiver). The method continues to 1410.

At 1410, when a result of the comparison exceeds a threshold value, the processing equipment parameters are adjusted based on the comparison result and the characterization data for the fabric/machine combination.

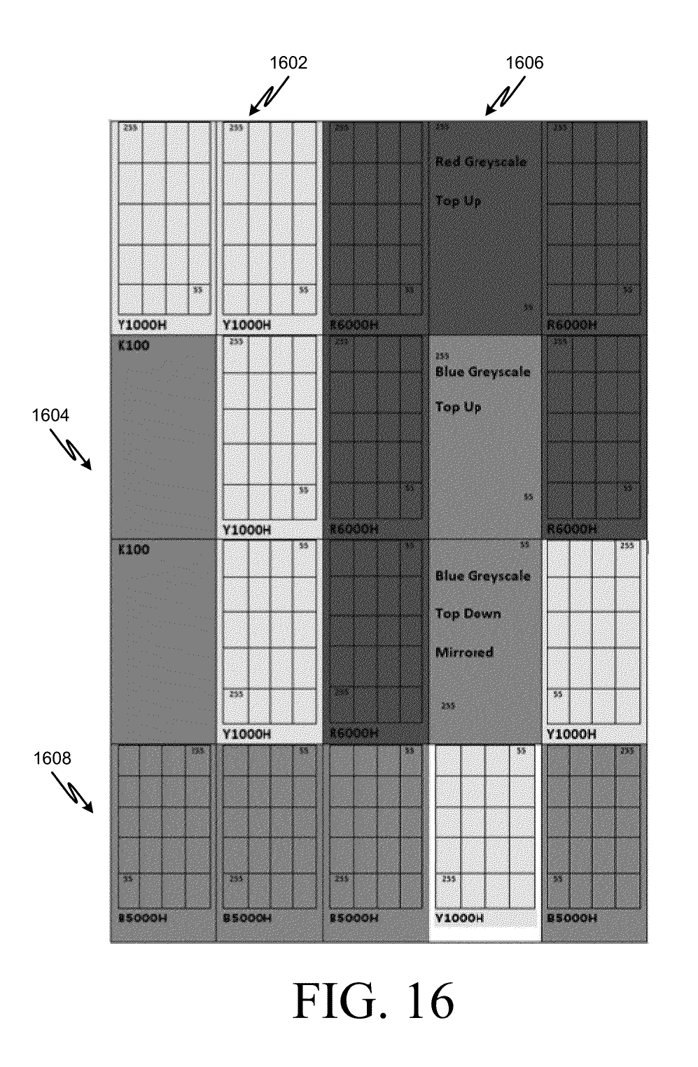

FIG. 15 is a diagram of an example computing device 1500 in accordance with at least one implementation. The computing device 1500 includes one or more processors 1502, a computer readable medium 1506, a network interface 1508 and an optional processing equipment interface 1514. The computer readable medium 1506 can have an operating system 704, a sublimation control application 1510 and a data section 1512 (e.g., for storing design orders to be printed, sublimation equipment/fabric characterization data, control set points, etc.).

In operation, the processor 1502 may execute the application 1510 stored in the computer readable medium 1506. The application 1510 can include software instructions that, when executed by the processor, cause the processor to perform operations for sublimation process control in accordance with the present disclosure (e.g., performing one or more of 1302-1310 and/or 1402-1410 described above).

The application program 1510 can operate in conjunction with the data section 1512 and the operating system 1504.

FIGS. 16 and 17 are diagrams of an example characterization template images. FIG. 16 shows 20 large blocks representing yellow, black, red and blue colors (shown by the different fill patterns at 1602, 1604, 1606 and 1608, respectively) at different locations on the transfer medium. Within each large block, there are 20 smaller blocks with tonal build-up scales from steps 55, 70, 90, 105, 114, 122, 130, 137, 147, 157, 170, 177, 184, 192, 200, 210, 220, 233, 246, to step 255. This carefully prepared consistent printed template is first folded in half and the fabric is placed within this folded envelope. It is placed into the nip of the transfer calendar machine fitted with a heater (e.g., an AirDye pulse heater), which heats up the blanket at the given permutation of the control parameter values. FIG. 17 includes descriptions of the 2×10 large color blocks with the first two rows being the front and back of the transferred fabric (i.e. front and back of the first row for the transferred fabric). Following these 2 rows are another 2 rows (i.e. front and back of the second row for the transferred fabric).

It will be appreciated that double-sided sublimation printing is described above for illustration purposes and that an implementation can include a calendar machine configured to print only one side of a receiver and the systems and methods can be configured to control a single-sided dye sublimation process and calendar machine.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for controlling dye sublimation processing equipment.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

1. A method for controlling a calendar machine, the method comprising:
providing a receiver and donor transfer media including a first donor transfer medium and a second donor transfer medium;
simultaneously applying, with the calendar machine, a first image from the first donor transfer medium on a first surface of the receiver and a second image from the second donor transfer medium on a second surface of the receiver, the calendar machine being configured with a parameter set including a time value, one or more temperature values and a pressure value;
obtaining, using a spectrophotometer, a first spectral measurement of the first surface of the receiver and a second spectral measurement of the second surface of the receiver;
comparing the first and second spectral measurements with respective reference measurements obtained from a characterization; and
when a result of the comparing exceeds a threshold value, adjusting one or more of the time value, the one or more temperature values and the pressure value.

2. The method of claim 1, further comprising initially configuring the calendar machine with an initial parameter set, wherein the initial parameter set for the calendar machine is received from a color management system, and wherein values of the initial parameter set are determined at the color management system based on the reference measurements.

3. The method of claim 1, wherein the receiver includes a synthetic fabric.

4. The method of claim 3, wherein the donor transfer media includes paper.

5. The method of claim 1, wherein the applying includes dye sublimation transfer, and wherein the first donor transfer medium and the second donor transfer medium each include one or more dyes compatible with dye sublimation transfer.

6. The method of claim 1, wherein the calendar machine includes a pulse heater.

7. The method of claim 1, wherein the obtaining, comparing and adjusting are performed by a controller coupled to the calendar machine.

8. The method of claim 7, wherein the controller includes a programmable logic controller.

9-15. (canceled)

16. A calendar system comprising:
a calendar machine configured to print both sides of a receiver simultaneously and configured with a parameter set including a time value, one or more temperature values and a pressure value;
a spectrophotometer configured to obtain spectral measurements from images of both surfaces of a printed receiver; and
a controller coupled to the calendar machine and the spectrophotometer, the controller configured to adjust one or more of the time value, the one or more temperature values and the pressure value of the calendar machine based on spectral measurements from the spectrophotometer obtained from the printed receiver, wherein the adjusting is based on comparing the spectral measurements with reference measurements from a characterization.

17. The system of claim 16, wherein the calendar machine is initially configured with an initial parameter set, wherein the initial parameter set for the calendar machine is received from a color management system, and wherein values of the initial parameter set are determined at the color management system based on the reference measurements.

18. The system of claim 16, wherein the substrate includes a fabric.

19. The system of claim 18, wherein the fabric includes synthetic material.

20. The system of claim 16, wherein the calendar machine is configured to print both side of the receiver simultaneously using dye sublimation transfer.

21. The system of claim 16, wherein the calendar machine includes a pulse heater.

22. The system of claim 16, wherein the controller includes a programmable logic controller.

23. A calendar machine control system comprising:
a spectrophotometer configured to obtain spectral measurements from images of both surfaces of a receiver; and
a controller coupled to a calendar machine interface and the spectrophotometer, the controller configured to provide parameters to a calendar machine, the parameters including one or more of a time value, one or more temperature values and a pressure value, the parameters being determined based on spectral measurements from the spectrophotometer obtained from a receiver printed using the calendar machine, wherein the adjusting is based on comparing the spectral measurements with reference measurements from a fabric characterization.

24. The system of claim 22, wherein the controller is configured to receive an initial parameter set from a color management system, and wherein values of the initial parameter set are determined at the color management system based on the reference measurements.

25. The system of claim 22, wherein the receiver includes a fabric.

26. The system of claim 25, wherein the fabric includes synthetic material.

27. The system of claim 22, wherein the calendar machine is configured to print both side of the receiver simultaneously using dye sublimation transfer.

28-73. (canceled)
